(19) United States
(12) Patent Application Publication
(10) Pub. No.: US 2026/0280904 A1
(43) Pub. Date: Sep. 17, 2026

(54) AUTHENTICATED ELECTRIC-VEHICLE CHARGING AND RENEWABLE-ENERGY SETTLEMENT USING A PERMISSIONED CONSORTIUM

(71) Applicants: SHAQRA UNIVERSITY, Shaqra (SA); TAIBAH UNIVERSITY, Madinah (SA); UNIVERSITY OF HAIL, Hail (SA)

(72) Inventors: Amjad ALDWEESH, Shaqra (SA); Maher ALHARBY, Madinah (SA); Talal ALHARBI, Hail (SA); Tuwailaa Turki ALSHAMMARI, Hail (SA)

(73) Assignees: SHAQRA UNIVERSITY, Shaqra (SA); TAIBAH UNIVERSITY, Madinah (SA); UNIVERSITY OF HAIL, Hail (SA)

(21) Appl. No.: 19/672,334

(22) Filed: May 8, 2026

(51) Int. Cl. H04L 9/32; H04L 9/08

(52) U.S. Cl. CPC H04L 9/3271; H04L 9/0863; H04L 9/321; H04L 9/3218

(57) ABSTRACT

The present disclosure relates to a device-based system for authenticated electric-vehicle charging and renewable-energy settlement using a permissioned consortium network. The system comprises a consortium control device having processing circuitry, memory, and cryptographic engines configured to generate and validate session-specific cryptographic challenge nonces, verify nonce-bound credential proofs, and evaluate policy attributes and risk indicators for admission. A charging station device communicates with the consortium control device and the electric vehicle and measures delivered electrical energy using an integrated metering unit. The electric vehicle includes a hardware-protected credential store for generating signed credential proofs. A renewable energy measurement device generates signed generation evidence verified prior to tokenization. The consortium control device includes a tokenization engine, a matching processor, and an escrow management module. A validation module verifies signed delivery evidence and compares delivered energy with requested energy.

### TECHNICAL FIELD

The present disclosure relates to electrically powered transportation systems and distributed energy management infrastructures, and more particularly to a device-centric system architecture for authenticated electric-vehicle charging integrated with renewable-energy tokenization and settlement using a permissioned consortium network.

### BACKGROUND

The increasing adoption of electric vehicles necessitates secure, interoperable, and verifiable charging infrastructures that ensure authentication of participating entities, integrity of energy delivery, and traceable settlement of renewable energy usage. Conventional charging systems lack robust mechanisms for cryptographic authentication, secure credential storage, and verifiable linkage between energy generation and consumption. Furthermore, existing settlement architectures fail to provide atomicity, tamper resistance, and coordinated escrow mechanisms across distributed participants.

The rapid growth of electric mobility and distributed renewable energy generation has led to the emergence of complex charging ecosystems in which electric vehicles, charging stations, grid operators, and energy producers interact in real time. Conventional electric-vehicle charging infrastructures were initially designed as isolated systems focused primarily on energy delivery rather than secure authentication, traceable energy sourcing, or verifiable financial settlement. These early systems typically relied on centralized authorization servers, static user credentials, and proprietary communication protocols, which created limitations in scalability, interoperability, and security. As electric-vehicle adoption increased, the need for more sophisticated mechanisms to authenticate vehicles, validate energy provenance, and enable seamless cross-network charging became evident. However, existing solutions continue to exhibit significant technical shortcomings that hinder reliable and secure operation at scale.

One category of existing solutions relies on centralized identity management architectures, wherein electric vehicles and charging stations authenticate against a remote server using pre-registered credentials such as RFID tokens, digital certificates, or account-based identifiers. While such approaches provide basic access control, they introduce single points of failure and are vulnerable to credential theft, replay attacks, and unauthorized duplication. In many deployments, credentials are stored in software-accessible memory without hardware-level protection, making them susceptible to extraction through physical or remote attacks. Furthermore, centralized identity systems often struggle with latency and availability issues, particularly when operating across geographically distributed charging networks, leading to degraded user experience and potential denial of service during peak demand conditions.

Another class of systems attempts to enhance authentication through public-key infrastructure mechanisms, wherein vehicles and charging stations exchange digitally signed messages.

Interoperability between different charging networks and energy markets is another area where existing solutions fall short. Many systems are developed using proprietary protocols and data formats, making it difficult to achieve seamless integration across multiple service providers. This lack of standardization hinders the creation of unified charging ecosystems and limits the ability of users to access charging services across different networks without undergoing redundant registration and authentication processes. Furthermore, the absence of common frameworks for tokenization and settlement of renewable energy complicates cross-network energy trading and utilization.

In addition to technical limitations, existing solutions often fail to provide mechanisms for ensuring atomicity and consistency in multi-step processes such as authentication, energy delivery, and settlement. Without atomic state transitions, intermediate states may become inconsistent due to partial failures, communication interruptions, or malicious interference. This can result in scenarios where payment is processed without corresponding energy delivery or vice versa. Current systems typically address such issues through post hoc reconciliation rather than preventing inconsistencies at the transactional level.

While existing electric-vehicle charging and renewable energy settlement systems have introduced various improvements in authentication, metering, and transaction processing, they continue to exhibit critical drawbacks related to security, scalability, interoperability, and data integrity. The lack of tightly integrated hardware-assisted authentication, real-time verification of renewable energy generation, robust tokenization mechanisms, and atomic settlement processes highlights the need for an advanced system architecture that overcomes these limitations and provides a secure, efficient, and verifiable framework for next-generation charging ecosystems.

### SUMMARY OF THE INVENTION

The present disclosure provides a device-based system comprising a consortium-controlled processing architecture, a charging station apparatus, an electric vehicle-integrated authentication module, a renewable energy measurement device, and a distributed secure storage system. The system enables authenticated charging sessions using cryptographic challenge-response protocols, validates renewable energy generation through signed evidence, performs tokenization of energy units, and executes atomic settlement operations using escrow-controlled transaction states.

The primary object of the present invention is to provide a device-based system for authenticated electric-vehicle charging and renewable-energy settlement that ensures secure, verifiable, and tamper-resistant interaction among electric vehicles, charging stations, and consortium-controlled infrastructure. The invention seeks to establish a hardware-integrated architecture in which authentication, energy measurement, and settlement processes are tightly coupled through cryptographic mechanisms and controlled processing units, thereby eliminating vulnerabilities associated with conventional software-centric or loosely integrated systems.

Another object of the invention is to provide a secure authentication mechanism employing a cryptographic challenge-response framework in which a session-specific nonce is generated, transmitted, and validated using hardware-protected credential stores within electric vehicles.

This object ensures that each charging session is uniquely bound to a verifiable identity and protected against replay attacks, credential duplication, and unauthorized access. The invention further aims to enable temporal validation and nonce reuse detection through dedicated memory structures and verification circuits, thereby enhancing session integrity.

A further object of the invention is to provide a system capable of verifying renewable energy generation in a secure and traceable manner by incorporating a renewable energy measurement device configured to generate signed generation evidence. The invention aims to ensure that only authenticated and attested energy generation sources contribute to tokenized energy records, thereby improving the reliability and credibility of renewable energy attribution within electric-vehicle charging processes.

Another object of the invention is to provide a tokenization mechanism that converts verified energy values into standardized token quantities using deterministic computational logic implemented in processing circuitry. This object ensures consistent, precise, and tamper-resistant representation of energy units, enabling accurate accounting and traceable utilization of renewable energy during charging sessions.

Another object of the invention is to provide a mechanism for validating delivered electrical energy through signed delivery evidence and cryptographic hash comparison of metering records. The invention seeks to ensure that energy delivery data remains consistent, verifiable, and resistant to tampering by establishing a secure linkage between metering devices, session records, and settlement processes.

A further object of the invention is to provide an atomic state transition mechanism that simultaneously updates payment and token states within a settlement record, thereby eliminating intermediate inconsistencies and ensuring transactional integrity. This object addresses limitations in existing systems by preventing partial completion of settlement operations and ensuring that all dependent actions are executed as a single, indivisible operation.

Another object of the invention is to provide a scalable and interoperable system architecture capable of supporting multiple charging stations, electric vehicles, and renewable energy sources within a permissioned consortium network. The invention seeks to facilitate seamless interaction across diverse entities while maintaining consistent security, authentication, and settlement standards.

A further object of the invention is to provide a metering and validation framework capable of generating intermediate and cumulative energy measurements during a charging session, thereby enabling continuous verification of energy delivery and detection of deviations beyond predefined tolerance thresholds. This object enhances accuracy and reliability in energy accounting and prevents discrepancies between requested and delivered energy quantities.

Another object of the invention is to provide a system incorporating firmware attestation and device integrity verification for renewable energy measurement units, ensuring that energy generation data originates from trusted execution environments. This object addresses potential vulnerabilities arising from compromised or altered metering devices.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 illustrates a flow chart of a method for a computer-implemented method for authenticated electric-vehicle charging and renewable-energy settlement;

FIG. 2 illustrates a block diagram of a system for authenticated electric-vehicle charging and renewable-energy settlement using a permissioned consortium network;

FIG. 3 illustrates a system for authenticated electric-vehicle charging and renewable-energy settlement using a permissioned consortium network;

FIG. 4 illustrates a sequence of operations for authenticated electric-vehicle charging and renewable-energy settlement, depicting interactions among an electric vehicle, a charging station, a consortium control system;

FIG. 5(a) illustrates authentication latency associated with admission of electric-vehicle charging sessions under increasing concurrency levels;

FIG. 5(b) illustrates settlement latency as a function of an offered transaction rate, where the horizontal axis represents the offered transaction rate in transactions per second and the vertical axis represents latency in seconds;

FIG. 6 illustrates a state transition representation of a charging session lifecycle executed within the authenticated electric-vehicle charging and renewable-energy settlement system; and

FIG. 7 illustrates representative data structures maintained within the permissioned consortium network for enabling authenticated electric-vehicle charging and renewable-energy settlement. Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

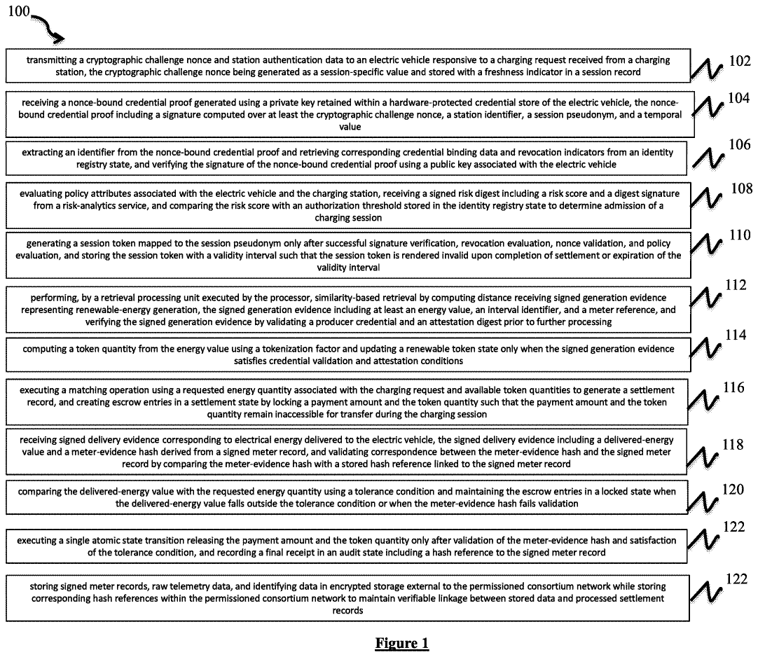

Referring to FIG. 1, a flow chart for a method for a computer-implemented method for authenticated electric-vehicle charging and renewable-energy settlement executed by a processor of a consortium control system associated with a permissioned consortium network is illustrated.

The method 100 comprising: At step 102, the method 100 includes transmitting a cryptographic challenge nonce and station authentication data to an electric vehicle responsive to a charging request received from a charging station, the cryptographic challenge nonce being generated as a session-specific value and stored with a freshness indicator in a session record;

At step 104, the method 100 includes receiving a nonce-bound credential proof generated using a private key retained within a hardware-protected credential store of the electric vehicle, the nonce-bound credential proof including a signature computed over at least the cryptographic challenge nonce, a station identifier, a session pseudonym, and a temporal value;

At step 106, the method 100 includes extracting an identifier from the nonce-bound credential proof and retrieving corresponding credential binding data and revocation indicators from an identity registry state, and verifying the signature of the nonce-bound credential proof using a public key associated with the electric vehicle while simultaneously comparing the cryptographic challenge nonce with the stored session-specific value and rejecting the nonce-bound credential proof when the cryptographic challenge nonce does not match the stored session-specific value or corresponds to a previously processed session;

At step 108, the method 100 includes evaluating policy attributes associated with the electric vehicle and the charging station, receiving a signed risk digest including a risk score and a digest signature from a risk-analytics service, and comparing the risk score with an authorization threshold stored in the identity registry state to determine admission of a charging session;

At step 110, the method 100 includes generating a session token mapped to the session pseudonym only after successful signature verification, revocation evaluation, nonce validation, and policy evaluation, and storing the session token with a validity interval such that the session token is rendered invalid upon completion of settlement or expiration of the validity interval;

At step 112, the method 100 includes receiving signed generation evidence representing renewable-energy generation, the signed generation evidence including at least an energy value, an interval identifier, and a meter reference, and verifying the signed generation evidence by validating a producer credential and an attestation digest prior to further processing;

At step 114, the method 100 includes computing a token quantity from the energy value using a tokenization factor and updating a renewable token state only when the signed generation evidence satisfies credential validation and attestation conditions;

At step 116, the method 100 includes executing a matching operation using a requested energy quantity associated with the charging request and available token quantities to generate a settlement record, and creating escrow entries in a settlement state by locking a payment amount and the token quantity such that the payment amount and the token quantity remain inaccessible for transfer during the charging session;

At step 118, the method 100 includes receiving signed delivery evidence corresponding to electrical energy delivered to the electric vehicle, the signed delivery evidence including a delivered-energy value and a meter-evidence hash derived from a signed meter record, and validating correspondence between the meter-evidence hash and the signed meter record by comparing the meter-evidence hash with a stored hash reference linked to the signed meter record;

At step 120, the method 100 includes comparing the delivered-energy value with the requested energy quantity using a tolerance condition and maintaining the escrow entries in a locked state when the delivered-energy value falls outside the tolerance condition or when the meter-evidence hash fails validation;

At step 122, the method 100 includes executing a single atomic state transition releasing the payment amount and the token quantity only after validation of the meter-evidence hash and satisfaction of the tolerance condition, and recording a final receipt in an audit state including a hash reference to the signed meter record; and

At step 124, the method 100 includes storing signed meter records, raw telemetry data, and identifying data in encrypted storage external to the permissioned consortium network while storing corresponding hash references within the permissioned consortium network to maintain verifiable linkage between stored data and processed settlement records.

In an embodiment, generating the cryptographic challenge nonce comprises computing the cryptographic challenge nonce using a composite nonce-construction sequence including concatenating a station identifier, a session pseudonym, a monotonically increasing counter stored in the session record, and a timestamp derived from a system clock of the consortium control system, applying a cryptographic hash function to the concatenated sequence to obtain a fixed-length nonce value, storing the fixed-length nonce value and the monotonically increasing counter in the session record, and subsequently validating the nonce-bound credential proof by reconstructing the concatenated sequence and recomputing the cryptographic hash function to verify correspondence with the stored fixed-length nonce value, such that replayed or reordered nonce-bound credential proofs are detected through mismatch in the reconstructed sequence.

In this embodiment, the nonce generation and validation mechanism is physically realized through coordinated operation of a processing unit, clock generation circuitry, and dedicated memory registers that retain session-specific parameters, thereby ensuring that the constructed nonce is both unique and reproducible only under identical hardware state conditions. When a charging request is initiated, the processor retrieves the station identifier from an interface register associated with the charging station, while the session pseudonym is fetched from a session allocation buffer. Simultaneously, a monotonic counter maintained within a protected memory segment is incremented using a hardware counter circuit that prevents rollback or duplication even under power interruptions. A timestamp is obtained from a continuously running system clock oscillator, which provides a high-resolution temporal value synchronized across the consortium control system. These four parameters are concatenated within a register-level assembly buffer in a predefined order, ensuring deterministic reconstruction during subsequent verification.

The concatenated sequence is then passed through a cryptographic hashing engine implemented either as a dedicated co-processor or an integrated hashing circuit within the processor architecture, producing a fixed-length nonce value with uniform bit distribution. This fixed-length output is written back into the session record along with the updated counter value, forming a tightly bound reference that reflects both temporal and sequential progression of the session. For example, in a scenario where multiple charging sessions are initiated in rapid succession at the same station, the monotonic counter ensures that even if timestamps are closely spaced, each nonce remains distinguishable, thereby eliminating ambiguity in session identification.

During validation of a received nonce-bound credential proof, the system reconstructs the original input sequence by retrieving the stored station identifier, session pseudonym, counter value, and timestamp from the session record. The same hashing circuitry is invoked to recompute the nonce, and the resulting value is compared at the bit level with the stored fixed-length nonce. Any deviation, even at a single-bit level, indicates that the credential proof does not correspond to the originally issued challenge. For instance, if an adversarial entity attempts to replay a previously intercepted credential proof in a different session or reorder messages across sessions, the mismatch in either the counter or timestamp component results in a different hash output, causing immediate rejection by the comparison logic.

This construction ensures that the nonce is not merely a random value but a deterministically derived sequence tied to both session progression and system time, enabling precise detection of replayed, delayed, or reordered authentication attempts. The integration of a monotonic counter with timestamp-based entropy further ensures that nonce generation remains collision-resistant even under high transaction throughput, while the requirement of exact reconstruction during validation enforces strict correspondence between issued challenges and received proofs. As a result, the system achieves a robust and verifiable authentication handshake that significantly strengthens session integrity and prevents unauthorized reuse of credentials in distributed charging environments.

In an embodiment, verifying the nonce-bound credential proof comprises parsing the nonce-bound credential proof to extract the temporal value and performing a bounded time-window validation by computing a difference between the temporal value and a current system time maintained by the consortium control system, comparing the difference against a stored temporal threshold, and rejecting the nonce-bound credential proof when the temporal value falls outside the bounded time-window, while additionally maintaining a nonce usage record indexed by the session pseudonym to detect reuse of previously accepted nonce-bound credential proofs.

In this embodiment, the verification of the nonce-bound credential proof is implemented through coordinated operation of parsing circuitry, time-reference hardware, and indexed memory structures that collectively enforce both temporal validity and single-use enforcement of authentication artifacts. Upon receipt of the credential proof, the processor routes the incoming data stream through a parsing engine configured to isolate structured fields, including the embedded temporal value. This extraction is performed using predefined field offsets stored in a control register, ensuring that the temporal component is consistently retrieved regardless of variations in transmission latency or packet segmentation. The extracted temporal value is then supplied to a comparison unit that operates in conjunction with a continuously running system clock maintained by a high-stability oscillator within the consortium control system.

The comparison unit computes a time difference by subtracting the extracted temporal value from the current clock value, with the operation executed using fixed-width arithmetic logic to avoid overflow or truncation errors. The resulting difference is evaluated against a temporal threshold stored in a protected configuration register. For example, if the threshold is configured to permit a deviation of only a few seconds, any credential proof generated outside this bounded interval such as one delayed due to interception or network replay-will produce a difference exceeding the threshold and will be rejected immediately by the control logic. This ensures that authentication is tightly coupled to real-time system conditions and cannot be exploited through delayed transmission or buffering attacks.

In parallel with temporal validation, the system maintains a nonce usage record implemented as an indexed memory table keyed by the session pseudonym. Each successfully verified nonce is written into this table along with its associated timestamp and a usage flag. The memory structure is designed to support rapid lookup operations, enabling the processor to check, prior to acceptance, whether the same nonce has already been recorded for the corresponding session. For instance, if an attacker attempts to reuse a previously accepted credential proof within the valid time window, the lookup operation will detect the presence of the nonce in the usage record and trigger rejection, even though the temporal condition alone might otherwise be satisfied.

The combined enforcement of bounded time-window validation and nonce reuse detection establishes a dual-layer verification mechanism in which both timing and uniqueness are strictly controlled by hardware-supported operations. The reliance on a continuously synchronized system clock and indexed nonce storage ensures that authentication decisions remain consistent across distributed nodes of the consortium control system. This approach reduces the risk of replay attacks, prevents duplication of session credentials, and enhances the reliability of authentication under high-throughput conditions where multiple credential proofs may be processed concurrently without ambiguity.

In an embodiment, retrieving the credential binding data further comprises accessing a credential record structured as a multi-field data object including a public key reference, an issuer signature, a credential issuance timestamp, and a revocation flag, and performing a hierarchical validation sequence including verifying the issuer signature using an issuer public key stored in the identity registry state, validating the credential issuance timestamp against a validity interval, and confirming absence of the revocation flag prior to performing signature verification of the nonce-bound credential proof.

In this embodiment, the retrieval and validation of credential binding data is carried out through a structured interaction between indexed memory storage, secure key repositories, and dedicated signature verification circuitry, thereby ensuring that only credentials with intact provenance and valid lifecycle status are permitted to proceed to authentication. When the identifier is extracted from the received credential proof, the processor initiates a lookup operation within an identity registry memory that is physically organized as an indexed data store, where each credential record is maintained as a multi-field data object. The record includes a reference to a public key stored in a secure key storage module, an issuer signature representing the authority that issued the credential, a timestamp indicating the issuance moment, and a revocation flag maintained as a state indicator. These fields are retrieved in a single read operation and temporarily loaded into a verification buffer for sequential processing.

The validation sequence is executed in a hierarchical manner to ensure that computational resources are not expended on invalid or compromised credentials. Initially, the issuer signature is processed by a signature verification engine that utilizes an issuer public key retrieved from a trusted key repository within the identity registry state. This operation confirms that the credential was generated by an authorized issuing entity and has not been altered since issuance. For example, if a malicious entity attempts to inject a forged credential with a manipulated public key reference, the signature verification circuitry detects the mismatch at this stage and terminates further processing, thereby preventing unauthorized credentials from progressing deeper into the system.

Following successful issuer validation, the processor evaluates the credential issuance timestamp against a predefined validity interval stored in protected configuration registers. This comparison is performed using hardware-assisted arithmetic logic that computes whether the current system time falls within the permissible lifetime of the credential. In a practical scenario, a credential issued for a limited-duration authorization-such as temporary charging access-will be rejected automatically if presented after its expiration, ensuring that outdated credentials cannot be reused beyond their intended operational window.

Subsequently, the revocation flag within the credential record is examined through a direct memory read operation. This flag is dynamically updated by the identity registry in response to security events such as credential compromise or administrative deactivation. If the revocation flag indicates an invalid state, the control logic immediately halts the verification pipeline, thereby preventing further use of the associated credential regardless of its structural correctness or timestamp validity. For instance, a vehicle credential that has been revoked due to suspected key leakage will be consistently rejected across all validation attempts, ensuring uniform enforcement of revocation decisions.

Only after these hierarchical checks—issuer authenticity, temporal validity, and revocation status—are successfully satisfied does the system proceed to verify the signature contained within the nonce-bound credential proof using the public key reference associated with the credential. This staged validation approach ensures that computationally intensive signature verification of the nonce-bound proof is performed only on credentials that have already passed foundational trust checks, thereby improving processing efficiency and reducing unnecessary load on cryptographic hardware. The overall arrangement ensures that credential verification is not a single-step operation but a layered process that enforces authenticity, validity, and active status, resulting in a robust authentication mechanism that minimizes acceptance of compromised or expired credentials while maintaining high throughput in multi-session charging environments.

In an embodiment, evaluating the policy attributes comprises retrieving a policy data structure indexed by the station identifier and the electric vehicle identifier, the policy data structure including a plurality of constraint fields, and computing a policy decision by executing a rule-evaluation sequence that compares the requested energy quantity, a geographic attribute derived from the station identifier, and a credential trust level against corresponding constraint fields, and generating a policy evaluation result stored in the session record for subsequent audit-state inclusion.

In this embodiment, policy evaluation is carried out through coordinated operation of indexed memory structures, comparison logic, and rule-execution circuitry that together enable deterministic admission decisions based on multiple operational constraints. When a charging request progresses past credential verification, the processor initiates a dual-key lookup using the station identifier and the electric vehicle identifier to access a policy data structure stored in a dedicated policy memory region. This data structure is physically organized as a multi-field record in which each constraint field is mapped to a specific hardware register or memory offset, allowing rapid retrieval without sequential scanning. The constraint fields include permissible energy limits, geographic restrictions encoded as location identifiers, and a trust-level threshold associated with the credential class of the vehicle.

Once the policy record is retrieved, the processor transfers the relevant parameters-such as the requested energy quantity from the charging request, the geographic attribute derived from the station identifier through a location-mapping table, and the credential trust level obtained from the identity registry-into a rule-evaluation unit. This unit performs parallel comparison operations using arithmetic and logical circuits to determine compliance with each constraint field. For instance, if a vehicle requests a high energy quantity at a station located in a constrained geographic zone where supply is limited, the comparison circuitry evaluates whether the requested quantity exceeds the allowable threshold defined in the policy record. Simultaneously, the trust level of the vehicle credential is compared against the minimum trust requirement, ensuring that only vehicles with sufficiently validated credentials can access higher energy allocations or restricted locations.

The rule-evaluation sequence is executed in a predefined order stored within a control register, ensuring that all policy decisions are derived consistently across different sessions and system nodes. Intermediate comparison results are latched in temporary registers, and a final decision signal is generated only when all constraint evaluations are complete. For example, a vehicle with a valid credential but operating in a restricted geographic region may pass trust-level validation but fail location-based constraints, leading to a rejection or modified authorization outcome. This deterministic evaluation prevents ambiguous or conflicting decisions that could arise in loosely structured policy systems.

The resulting policy decision, whether admission, restriction, or denial, is then encoded into a structured result value and written into the session record within session memory. This stored result is subsequently referenced during later stages such as session token generation and audit recording, ensuring that the basis for the decision is preserved and can be verified independently. By binding the policy evaluation outcome directly to the session record, the system enables traceable and reproducible decision-making, which is particularly important in distributed environments where multiple control nodes may need to validate the same session state.

In an embodiment, receiving the signed risk digest comprises verifying the digest signature using a verification key associated with the risk-analytics service, extracting a model-version identifier and a digest reference from the signed risk digest, computing a hash over the model-version identifier and the digest reference, and storing the computed hash in the audit state in association with the session record to provide traceability of the risk evaluation applied during admission.

In this embodiment, the reception and validation of the signed risk digest is implemented through a combination of input interface circuitry, cryptographic verification hardware, and audit-state memory structures that together ensure that externally supplied risk assessments are both authentic and traceable. When the signed risk digest is received from the risk-analytics service, it is first buffered in an input register and passed to a signature verification engine that operates using a verification key stored in a secure key repository within the consortium control system. This verification engine performs a signature check over the entire digest payload, confirming that the risk score and associated metadata have not been altered during transmission and originate from an authorized analytics source. For example, if an unauthorized entity attempts to inject a fabricated low-risk score to gain access to a charging session, the signature verification circuitry detects the inconsistency and rejects the digest before any further processing occurs.

Upon successful signature verification, the processor extracts the model-version identifier and the digest reference from predefined positions within the validated digest structure. These extracted elements are transferred into a hashing module that applies a cryptographic hash function to generate a fixed-length hash value representing the exact combination of the analytics model version and the digest content reference. This operation ensures that both the analytical logic used to compute the risk score and the specific data context of that computation are compactly bound into a single verifiable value. In a practical scenario, if the risk-analytics service updates its evaluation model, the resulting model-version identifier changes, leading to a different computed hash even if similar input conditions are present, thereby enabling differentiation between decisions made under different analytical frameworks.

The computed hash is then written into an audit-state memory region alongside the corresponding session record, using an indexed association that links the risk evaluation to the specific charging session. This storage operation is performed through controlled write circuitry that ensures immutability of the recorded value once committed. As a result, during subsequent auditing or dispute resolution, the system can recompute the hash from the stored model-version identifier and digest reference and compare it with the recorded value to confirm that the same risk evaluation context was applied at the time of admission. For instance, if a discrepancy arises regarding why a particular charging session was approved or denied, the stored hash enables reconstruction and verification of the exact analytical inputs and model conditions used during the decision process.

This arrangement ensures that risk evaluation is not treated as an opaque external input but is instead integrated into the system with verifiable provenance and reproducibility. By binding the risk assessment to both its originating model version and its data reference, and by preserving this binding within the audit state, the system maintains a consistent and verifiable record of decision inputs. This enhances accountability across distributed control nodes and prevents inconsistencies that could otherwise arise from model updates, data tampering, or unauthorized risk score injection, while maintaining efficient processing through hardware-assisted verification and hashing operations.

In an embodiment, generating the session token comprises constructing the session token as a structured data object including the session pseudonym, a token identifier, a validity interval, and a station-binding value, applying a cryptographic signing operation over the structured data object using a private key associated with the consortium control system, storing a hash of the structured data object in the audit state, and subsequently validating the session token during processing by recomputing the hash and comparing it with the stored hash to detect tampering.

In an embodiment, receiving the signed generation evidence further comprises extracting the meter reference and retrieving a corresponding attestation digest including a firmware measurement value, comparing the firmware measurement value with a trusted measurement value stored in the identity registry state, and permitting computation of the token quantity only when the firmware measurement value matches the trusted measurement value, such that generation evidence originating from altered execution environments is excluded from tokenization.

In this embodiment, the generation and validation of the session token is executed through a coordinated interaction between structured data assembly registers, secure key storage modules, cryptographic signing circuitry, and audit-state memory, thereby ensuring that the session token remains bound to its originating context and resistant to manipulation. Once the charging session satisfies authentication and policy conditions, the processor constructs the session token by assembling the session pseudonym, a uniquely generated token identifier derived from a hardware counter, a validity interval obtained from configuration registers, and a station-binding value associated with the originating charging interface. These elements are arranged in a predefined format within a structured data buffer to ensure deterministic encoding. The assembled structure is then routed to a signing engine that accesses a private key retained within a protected key storage unit, where the signing operation produces a signature that is intrinsically linked to the exact content and ordering of the structured data object. This ensures that any modification to even a single field results in a signature mismatch during subsequent validation.

Following the signing operation, the processor invokes a hashing module to compute a fixed-length hash over the structured data object, excluding or including the signature based on implementation configuration, and writes this hash into an audit-state memory region alongside the corresponding session record. This stored hash serves as a compact integrity reference that can be rapidly accessed during later processing stages. For example, when the session token is presented during energy delivery or settlement, the system reconstructs the structured data object from the token, recomputes the hash using the same hashing circuitry, and performs a bit-level comparison with the stored hash value. Any discrepancy indicates that the token has been altered, truncated, or improperly regenerated, leading to immediate rejection. This mechanism ensures that the session token remains verifiably consistent throughout its lifecycle and cannot be reused across stations or sessions due to the embedded station-binding value and validity interval constraints.

In the related embodiment concerning receipt of signed generation evidence, the system extends its verification pipeline to ensure that the origin of energy generation data is tied to a trusted execution environment. Upon receiving the signed generation evidence, the processor extracts the meter reference and initiates a retrieval operation within the identity registry state to obtain a corresponding attestation digest. This digest includes a firmware measurement value that represents a cryptographic characterization of the firmware loaded within the metering device at the time of energy generation. The retrieved measurement is compared against a trusted measurement value stored in a protected registry, using comparison circuitry designed to detect even minimal deviations.

For instance, if a metering device has been altered to manipulate reported energy values, the firmware measurement value embedded within the attestation digest will differ from the trusted reference stored in the registry. The comparison operation detects this deviation and prevents further processing of the associated generation evidence, thereby blocking the creation of token quantities derived from untrusted or tampered sources. Conversely, when the measurement values match, the system proceeds to compute the token quantity, ensuring that only energy data originating from verified and unaltered execution environments contributes to the renewable token state.

This dual arrangement ensures that both session authorization and energy tokenization are anchored in verifiable, hardware-supported integrity checks. The session token mechanism guarantees that session identity and permissions remain intact and non-transferable, while the attestation-based validation of generation evidence ensures that only trustworthy metering inputs influence settlement outcomes. Together, these processes establish a secure linkage between session control and energy provenance, reducing the risk of fraudulent participation and ensuring that all recorded transactions reflect authentic and validated operational conditions.

In an embodiment, computing the token quantity comprises converting the energy value into a normalized unit using a scaling factor, applying the tokenization factor using fixed-point arithmetic with a predetermined precision level, generating an intermediate token value, and applying a deterministic rounding rule defined in the renewable token state to obtain the token quantity stored in the renewable token state.

In this embodiment, the computation of the token quantity is implemented through a sequence of deterministic arithmetic operations executed by a fixed-point processing unit, coupled with scaling registers and rounding control logic, thereby ensuring that energy-to-token conversion remains precise, reproducible, and independent of floating-point variability. When signed generation evidence is validated, the processor first retrieves the raw energy value from the input buffer and routes it through a normalization stage where a scaling factor, stored in a configuration register, is applied. This scaling factor converts the incoming energy measurement—such as watt-hours or kilowatt-hours—into a standardized internal unit used uniformly across the system. The normalization is performed using fixed-width arithmetic circuits, ensuring that even under varying measurement granularities from different metering devices, the resulting normalized value remains consistent and directly comparable. Following normalization, the tokenization factor is applied using a fixed-point arithmetic engine configured with a predetermined precision level defined by a precision register. This precision level governs the number of fractional bits retained during computation, allowing the system to balance granularity and computational efficiency. For example, in a scenario where small increments of renewable energy are generated, the fixed-point unit preserves fractional contributions up to the configured precision, ensuring that micro-generation events are not lost due to truncation. The multiplication of the normalized energy value with the tokenization factor produces an intermediate token value stored in an accumulator register.

The intermediate value is then processed by a rounding control unit that enforces a deterministic rounding rule defined within the renewable token state. This rule may specify, for instance, rounding toward zero, rounding to the nearest representable unit, or rounding based on threshold comparison, and is implemented using comparator and bit-shift logic to ensure uniform application across all computations. For example, if the intermediate token value falls just below a rounding threshold, the control unit ensures that the same rounding decision is applied consistently across all nodes, preventing divergence in token quantities due to minor computational differences.

The final token quantity, obtained after rounding, is written into the renewable token state memory along with an association to the corresponding generation evidence. This stored value represents a standardized and verifiable conversion of energy into token units, enabling consistent settlement and matching operations in subsequent stages. By relying entirely on fixed-point arithmetic and deterministic rounding rules implemented in hardware-supported logic, the computation avoids inconsistencies that could arise from floating-point representations, ensures uniformity across distributed processing nodes, and maintains precise accounting of energy contributions even at fine granularity levels.

In an embodiment, executing the matching operation comprises constructing an ordered list of available token quantities, sorting the ordered list based on a composite score computed from a price parameter, a time parameter, and a policy-derived weighting factor, iteratively selecting token quantities from the ordered list until the requested energy quantity is satisfied, and generating the settlement record including identifiers of the selected token quantities and associated pricing data.

In this embodiment, the execution of the matching operation is realized through coordinated operation of structured memory buffers, scoring logic, and deterministic sorting circuitry, ensuring that allocation of token quantities is both optimal and reproducible under identical input conditions. When a charging request reaches the settlement stage, the processor retrieves all available token quantities from the renewable token state and loads them into an ordered list structure maintained within a high-speed memory buffer. Each entry in this structure includes not only the token quantity but also associated attributes such as a price parameter, a timestamp indicating generation or availability, and a source or policy-derived weighting factor. These attributes are mapped into dedicated registers for parallel processing.

A composite score for each token entry is then computed using arithmetic logic units that combine the price parameter, time parameter, and weighting factor according to a predefined computation sequence stored in control registers. For instance, the price parameter may be scaled to reflect cost efficiency, the time parameter may be weighted to prioritize more recent or time-sensitive tokens, and the policy-derived factor may adjust priority based on regulatory or operational preferences. These values are combined using fixed-point arithmetic operations to produce a normalized composite score for each token entry, ensuring that all entries are evaluated on a consistent numerical basis regardless of their original scales.

Once the composite scores are computed, the ordered list is passed through a sorting module that arranges the entries in a deterministic order based on their composite scores. The sorting operation is implemented using a defined comparison sequence that ensures identical ordering across different processing nodes when presented with the same input set. For example, if two token entries have similar scores, the sorting logic applies a secondary comparison using timestamp or identifier values to maintain a consistent and non-ambiguous order. This eliminates non-deterministic selection behavior and ensures that settlement outcomes remain consistent across distributed environments.

Following sorting, the processor initiates an iterative selection sequence in which token quantities are sequentially drawn from the ordered list and accumulated until the requested energy quantity associated with the charging session is satisfied. During this process, an accumulator register tracks the cumulative quantity of selected tokens, and comparison logic continuously evaluates whether the accumulated value meets or exceeds the requested requirement. For example, if a charging request requires a specific energy amount, the system selects tokens in priority order, potentially combining multiple smaller token quantities to reach the target, while ensuring that no excess allocation beyond defined tolerance limits occurs. As each token quantity is selected, its identifier and associated pricing data are recorded into a settlement buffer, which is subsequently used to generate a settlement record. This record includes a complete mapping of selected token identifiers, their corresponding contribution to the total energy requirement, and the pricing parameters applied during selection. The generation of this structured settlement record ensures that every allocation decision is explicitly captured and can be independently verified during auditing or dispute resolution.

In an embodiment, locking the payment amount and the token quantity comprises creating escrow entries including a payment lock identifier and a token lock identifier, associating the escrow entries with the settlement record, storing a lock state indicator in the settlement state, and preventing modification or release of the escrow entries until execution of the atomic state transition. When the matching operation produces a settlement record, the processor invokes a lock-generation routine in which a payment lock identifier and a token lock identifier are created using a hardware-backed identifier generator, such as a monotonic counter combined with session-specific inputs to ensure uniqueness across concurrent transactions. These identifiers are written into escrow entry structures maintained within a protected settlement memory region, with each escrow entry containing references to the corresponding payment amount and token quantity.

The association between the escrow entries and the settlement record is established by embedding the lock identifiers within the settlement record structure and storing cross-references in indexed memory tables. This ensures that any subsequent access to the payment amount or token quantity must be validated against the corresponding lock identifiers. For example, if an external request attempts to modify the reserved payment amount while the charging session is ongoing, the access-control circuitry checks for the presence of valid lock identifiers and rejects the operation if the request does not include matching credentials, thereby preventing unauthorized alteration.

A lock state indicator is simultaneously written into the settlement state memory, representing that the associated resources are in a reserved and non-transferable condition. This indicator is maintained in a dedicated flag register and is continuously monitored by the control logic governing state transitions. While this indicator remains active, all write or release operations targeting the locked payment amount or token quantity are intercepted and blocked at the hardware access layer. In a practical scenario, even if multiple processes attempt concurrent updates to the same settlement entry, the presence of the lock state ensures that no partial updates or premature releases can occur.

The escrow entries remain in this protected state until the system executes the atomic state transition that finalizes the settlement. During this transition, the control logic verifies that all required validation conditions-such as delivery evidence integrity and tolerance compliance have been satisfied. Only upon successful validation does the system simultaneously release both the payment amount and the token quantity by clearing the lock state indicator and invalidating the associated lock identifiers. This coordinated release ensures that neither resource can be independently accessed or transferred prior to completion of all conditions, thereby eliminating the possibility of inconsistent or partial settlement outcomes.

This arrangement provides a robust mechanism for maintaining transactional integrity throughout the charging session by ensuring that reserved financial and energy assets remain securely locked and consistently associated with the corresponding settlement record. The use of unique lock identifiers, enforced access control, and state-dependent release conditions ensures that resource allocation remains synchronized and protected against concurrent modification, thereby supporting reliable and conflict-free settlement execution in distributed environments.

In an embodiment, receiving the signed delivery evidence further comprises computing the meter-evidence hash by applying a cryptographic hash function to the signed meter record, retrieving a stored hash reference corresponding to the signed meter record from the permissioned consortium network, and comparing the computed meter-evidence hash with the stored hash reference to validate integrity of the signed meter record.

In this embodiment, validation of the signed delivery evidence is carried out through a coordinated interaction between data buffering circuits, cryptographic hashing hardware, and indexed retrieval mechanisms that ensure the integrity of metering information before it influences settlement decisions. When the signed delivery evidence is received, the processor extracts the associated signed meter record and loads it into a hashing input buffer. This buffer feeds a cryptographic hashing engine, implemented as a dedicated hardware module or tightly integrated processing unit, which processes the entire meter record in a deterministic manner to generate a fixed-length meter-evidence hash. The hashing operation ensures that any variation in the underlying meter record, even at a single-bit level, results in a distinct hash output, thereby providing a sensitive integrity fingerprint of the delivered energy data.

In parallel, the processor initiates a retrieval operation within the permissioned consortium network state to obtain a previously stored hash reference corresponding to the same signed meter record. This reference is accessed through an indexed lookup using identifiers associated with the session or the meter source, ensuring that the correct reference value is obtained without ambiguity. The retrieved hash reference represents the expected integrity value recorded at the time the meter record was originally registered or anchored within the system.

The computed meter-evidence hash is then supplied to a comparison unit where it is evaluated against the retrieved hash reference using bit-level comparison circuitry. This comparison is executed in a single-cycle or pipelined operation to ensure rapid validation even under high transaction throughput. For example, if the signed meter record has been altered during transmission or storage—such as through insertion, deletion, or modification of measurement values—the recomputed hash will differ from the stored reference, and the comparison logic will immediately flag the discrepancy. Upon detection of such a mismatch, the control unit prevents further progression of the delivery evidence within the settlement pipeline, thereby ensuring that tampered or inconsistent metering data cannot influence payment release or token settlement.

Conversely, when the computed hash matches the stored reference exactly, the system confirms that the signed meter record has been preserved without alteration from its original recorded state. This confirmation allows subsequent processing steps, such as energy validation and escrow release, to proceed with confidence in the authenticity and integrity of the delivery data. For instance, in a distributed charging scenario where meter data may traverse multiple nodes before reaching the consortium control system, this validation mechanism ensures that the final settlement decision is based on unmodified and verifiable measurements. By anchoring the integrity verification process in deterministic hashing and reference comparison, this embodiment ensures that all delivery evidence is cryptographically bound to its original recorded form. The use of hardware-supported hashing and rapid comparison logic enables efficient validation without introducing latency, while the reliance on stored hash references within the consortium network provides a persistent and verifiable linkage between recorded and received data. This approach effectively eliminates the risk of undetected data tampering and ensures that settlement outcomes are derived from authentic and consistent metering inputs.

In an embodiment, comparing the delivered-energy value with the requested energy quantity comprises computing an energy deviation value, comparing the energy deviation value with a tolerance threshold stored in the settlement state, and maintaining the escrow entries in a locked state when the energy deviation value exceeds the tolerance threshold, while recording a deviation indicator in the audit state.

In this embodiment, the comparison between the delivered-energy value and the requested energy quantity is executed through arithmetic computation units, threshold registers, and state-control logic that collectively ensure that settlement release is conditioned on acceptable delivery accuracy. Once the signed delivery evidence has been validated for integrity, the processor retrieves both the delivered-energy value and the originally requested energy quantity from their respective memory locations and feeds them into a subtraction unit configured to compute an energy deviation value. This computation is performed using fixed-width arithmetic to maintain precision and avoid rounding inconsistencies, with the resulting deviation value representing the absolute or signed difference between the two quantities depending on system configuration.

The computed deviation value is then routed to a comparison circuit that operates against a tolerance threshold stored in a protected register within the settlement state. This threshold is predefined based on permissible measurement variations, accounting for factors such as meter resolution, transmission latency, or minor fluctuations in energy delivery. For example, if a charging session is expected to deliver a specific energy amount but the measured delivery differs slightly due to hardware tolerances, the comparison logic allows such minor deviations to pass, provided they remain within the configured threshold. However, if the deviation exceeds this threshold—such as in cases of under-delivery, over-delivery, or inconsistent metering—the comparison circuit generates a rejection signal.

Upon detection of a deviation exceeding the permissible limit, the control logic maintains the escrow entries in their locked state by preserving the lock state indicator within the settlement memory and preventing any release operation. This ensures that neither the payment amount nor the associated token quantity is transferred prematurely under conditions of mismatch. In addition, the system records a deviation indicator within the audit state by writing a status flag along with the computed deviation value and associated session identifier. This recorded information provides a verifiable trace of the discrepancy, enabling subsequent analysis, dispute resolution, or corrective actions.

Conversely, when the deviation value falls within the acceptable threshold, the comparison circuitry allows the process to proceed toward the final settlement stage without altering the locked state until all remaining validation steps are satisfied. This ensures that release conditions are met only when delivery accuracy is confirmed within defined operational limits. By incorporating precise deviation computation and threshold-based validation into the settlement pipeline, the system ensures that energy delivery and financial settlement remain tightly aligned, prevents discrepancies from propagating into finalized transactions, and provides a consistent mechanism for handling measurement variations while maintaining transactional integrity.

In an embodiment, executing the atomic state transition comprises generating a transaction record including the payment amount, the token quantity, and the delivered-energy value, applying a consensus validation procedure across the permissioned consortium network, and updating the settlement state and audit state in a single write operation such that intermediate release of either the payment amount or the token quantity is prevented.

In this embodiment, the atomic state transition is realized through tightly coordinated operation of transaction assembly registers, network validation interfaces, and synchronized memory write control circuitry to ensure that settlement completion occurs as an indivisible operation without intermediate exposure of reserved resources. Once all prior validation stages—such as credential verification, delivery integrity, and deviation checks—are satisfied, the processor constructs a transaction record by aggregating the payment amount, the token quantity, and the delivered-energy value into a structured record buffer. This aggregation is performed in a dedicated assembly region where each field is mapped to fixed offsets, ensuring deterministic encoding and consistent interpretation across all participating nodes.

The constructed transaction record is then passed to a validation interface that communicates with peer nodes within the permissioned consortium network. Through this interface, the record is subjected to a consensus validation procedure in which multiple nodes independently verify the correctness of the transaction data, including the integrity of associated references and compliance with previously stored state conditions. For example, each participating node may recompute relevant hashes, confirm that escrow locks are valid, and verify that the delivered-energy value aligns with recorded evidence. The transaction proceeds only when the validation responses from the network satisfy predefined acceptance conditions, ensuring that no single node can unilaterally finalize the settlement.

Upon successful validation, the processor triggers a synchronized write operation controlled by a commit logic unit that governs updates to both the settlement state and the audit state. This commit logic ensures that all related memory locations are updated within a single execution window, preventing partial writes or staggered updates. For instance, the release of the payment amount and the corresponding transfer of token quantity are executed simultaneously by clearing the associated lock indicators and updating ownership records in one coordinated operation. The audit state is updated concurrently with a finalized record that includes references to the transaction record, thereby preserving a verifiable history of the completed settlement.

If any component of the validation process fails or if the commit operation cannot be completed in a single synchronized cycle, the system aborts the transition and retains the previous state, including maintaining the escrow locks. This rollback behavior ensures that no intermediate condition arises in which one asset is released while the other remains locked, thereby eliminating inconsistencies and preventing partial settlement scenarios. For example, a failure in network validation after partial processing does not result in release of funds or tokens, as the commit logic enforces an all-or-nothing update.

Through this arrangement, the state transition mechanism guarantees that settlement completion is executed as a single, indivisible operation governed by both local validation and distributed agreement. The integration of consensus validation with synchronized state updates ensures that all participating nodes maintain a consistent view of the transaction outcome, while the prevention of intermediate release conditions preserves the integrity of financial and energy asset transfers throughout the process.

In an embodiment, storing the signed meter records comprises encrypting the signed meter records using an encryption key associated with the consortium control system, generating a corresponding hash reference using a cryptographic hash function, storing the encrypted signed meter records in storage external to the permissioned consortium network, and storing the corresponding hash reference within the permissioned consortium network to enable later verification without exposing the encrypted signed meter records.

In this embodiment, the storage of signed meter records is implemented through coordinated operation of encryption circuitry, external storage interfaces, and hash-generation modules to ensure that sensitive metering data remains protected while still being verifiable within the consortium environment. Once a signed meter record is validated and prepared for storage, the processor routes the record to an encryption engine that applies a symmetric or asymmetric encryption operation using a key retained within a secure key storage unit of the consortium control system. This encryption process transforms the meter record into a protected data form that cannot be interpreted without access to the corresponding decryption key. For example, detailed consumption patterns or device identifiers embedded within the meter record are rendered inaccessible in external storage, thereby preserving confidentiality even if the storage medium is accessed by unauthorized entities.

Following encryption, the processor generates a hash reference by applying a cryptographic hash function to either the original signed meter record or the encrypted output, depending on system configuration. This hashing operation is executed by a dedicated hashing module that produces a fixed-length digest uniquely representing the content of the record. The resulting hash reference serves as a compact integrity anchor that can later be used to confirm whether the stored data has been altered. Because the hash function is sensitive to any modification, even a minor change in the stored record would result in a different hash value, enabling reliable detection of tampering.

The encrypted signed meter record is then transmitted through a storage interface to an external storage system that resides outside the permissioned consortium network. This external storage may include distributed storage nodes or archival systems optimized for large data volumes. By offloading the full meter record to external storage, the system reduces the storage burden on the consortium network while still preserving access to the data when required. The transmission is performed through controlled data channels to ensure that the encrypted payload is written accurately and associated with a retrievable storage reference.

Simultaneously, the computed hash reference is written into the permissioned consortium network state and linked to the corresponding session or transaction record. This stored hash acts as a persistent verification reference that remains within the controlled network environment. When verification is required at a later stage, the encrypted meter record can be retrieved from external storage, decrypted using the appropriate key, and reprocessed through the same hashing module to recompute its hash. The recomputed value is then compared with the stored hash reference to confirm that the record has remained unchanged since its original storage.

In an embodiment, generating the cryptographic challenge nonce comprises constructing a nonce input sequence including a station identifier, the session pseudonym, a monotonic counter stored in the session record, and a timestamp value, applying a keyed cryptographic hash function to the nonce input sequence using a secret key stored within the consortium control system to produce the cryptographic challenge nonce, storing the monotonic counter and the timestamp value in the session record, and validating the nonce-bound credential proof by reconstructing the nonce input sequence and recomputing the keyed cryptographic hash function to detect deviation between the reconstructed cryptographic challenge nonce and the transmitted cryptographic challenge nonce. When a charging session is initiated, the processor assembles the nonce input sequence by retrieving the station identifier from an interface register, the session pseudonym from a session allocation buffer, and a monotonic counter maintained within a protected hardware counter block that increments in a non-resettable manner even across transient interruptions. A timestamp value is simultaneously acquired from a system clock module driven by a stable oscillator, ensuring consistent temporal progression across all sessions. These elements are concatenated in a predefined order within a register-level buffer to form a structured input sequence.

This sequence is then provided to a keyed cryptographic hashing engine that operates using a secret key retained within a secure key storage module isolated from general memory access. The keyed hashing operation binds the input sequence with the secret key, producing a cryptographic challenge nonce that cannot be predicted or reproduced without access to the same key and identical input parameters. For example, even if an external entity observes multiple nonce values generated by the system, the absence of the secret key prevents derivation of the underlying sequence or prediction of future nonce values, thereby strengthening resistance against precomputation or forgery attempts. The processor stores the monotonic counter value and the timestamp in the session record immediately after nonce generation, ensuring that the exact parameters used in the keyed hash can be retrieved for subsequent verification. During validation of a received nonce-bound credential proof, the system reconstructs the original nonce input sequence by reading the stored station identifier, session pseudonym, counter value, and timestamp from the session record. This reconstructed sequence is then processed through the same keyed hashing engine using the identical secret key, generating a recomputed nonce value.

A comparison unit performs a bit-level evaluation between the recomputed nonce and the nonce included in the received credential proof. Any deviation indicates that the credential proof does not correspond to the originally issued challenge, either due to tampering, replay, or attempted fabrication. For instance, if an adversary attempts to reuse a previously captured credential proof in a different session context, the mismatch in the counter or timestamp component results in a different keyed hash output, leading to immediate rejection by the validation logic.

This approach ensures that nonce generation is not only unique per session but also cryptographically bound to a secret key and specific system state parameters, making it infeasible to replicate outside the trusted execution environment. The combination of monotonic progression, time-based variability, and keyed hashing provides strong protection against replay and prediction, while the deterministic reconstruction process ensures reliable validation without ambiguity, even in high-throughput scenarios involving multiple concurrent authentication requests.

In an embodiment, verifying the nonce-bound credential proof further comprises performing a dual-binding validation including verifying that the signature is computed over both the cryptographic challenge nonce and the station identifier and verifying that the station identifier included in the nonce-bound credential proof corresponds to a station identifier stored in the session record, and rejecting the nonce-bound credential proof when either binding condition is not satisfied.

In this embodiment, the verification of the nonce-bound credential proof is extended through a dual-binding validation mechanism implemented using coordinated operation of signature verification circuitry, field comparison logic, and session-bound memory registers to ensure that the authentication artifact is inseparably tied to both the issued challenge and the originating charging interface. Upon receipt of the credential proof, the processor routes the data into a parsing module that extracts the signed payload components, including the cryptographic challenge nonce and the station identifier embedded within the proof. These extracted values are loaded into verification registers and supplied to a signature verification engine that operates using the public key associated with the electric vehicle credential. The signature verification engine evaluates whether the signature has been computed over the exact combination of the cryptographic challenge nonce and the station identifier by reconstructing the signed data sequence in a predefined format and applying the verification algorithm. This ensures that the nonce is not validated in isolation but is cryptographically bound to the specific station context. For example, if a credential proof originally generated for one charging station is intercepted and replayed at a different station, the absence of the correct station identifier within the signed payload will cause the signature verification process to fail, as the reconstructed data sequence will not match the originally signed content.

In parallel, the processor performs a direct comparison between the station identifier extracted from the credential proof and the station identifier stored in the session record established at the time of nonce generation. This comparison is executed using equality-check logic that operates at the bit level, ensuring precise matching without tolerance for deviation. If the station identifier in the credential proof differs from the stored value—even by a minor alteration—the comparison circuitry generates a mismatch signal. For instance, if an adversarial entity attempts to modify the station identifier field to redirect a valid credential proof to another station, the mismatch is immediately detected and the proof is rejected.

Both validation conditions are evaluated in a coordinated manner, with the control logic requiring successful completion of the signature verification and the station identifier comparison before permitting further processing. If either condition fails, the system terminates the authentication sequence and flags the credential proof as invalid, preventing any subsequent authorization or session progression. This dual-binding approach ensures that the credential proof is tightly coupled to both the issued nonce and the specific station context, eliminating the possibility of cross-station replay or misuse of valid authentication data. By enforcing simultaneous binding to the challenge and the station identity, the system achieves a higher degree of contextual integrity in the authentication process. The use of hardware-supported signature verification and precise comparison logic ensures that these checks are performed efficiently and consistently, even under high transaction loads, while preventing unauthorized reuse or redirection of credential proofs across different charging endpoints.

In an embodiment, generating the session token further comprises encoding the session token as a structured data object including the session pseudonym, a token identifier, a validity interval, and a nonce reference, computing a token hash by applying a cryptographic hash function over the structured data object, signing the token hash using a private key associated with the consortium control system to generate a signed token value, storing the token hash in the audit state, and validating the session token during subsequent processing by recomputing the token hash and comparing it with the stored token hash. Once a charging session is admitted, the processor assembles the session token in a predefined format by placing the session pseudonym, a token identifier derived from a hardware-backed identifier generator, a validity interval obtained from configuration registers, and a nonce reference associated with the original challenge into a structured data buffer. This encoding is performed using fixed field positions and lengths so that the resulting structure can be deterministically reconstructed during later verification stages.

The assembled structured data object is then passed through a cryptographic hashing module that produces a fixed-length token hash representing the exact content of the token. This hashing operation ensures that any modification to the token structure, including changes to the pseudonym, identifier, validity interval, or nonce reference, results in a different hash output. The generated token hash is subsequently routed to a signing engine that applies a private key stored within a secure key storage unit of the consortium control system. The signing operation produces a signed token value that is intrinsically bound to the computed hash, thereby linking the authenticity of the token to its exact content without exposing the private key outside the protected environment.

Following signature generation, the processor stores the token hash in an audit-state memory region in association with the corresponding session record. This stored hash serves as a persistent integrity reference that can be accessed during subsequent stages of the charging session, such as energy delivery validation or settlement processing. For example, when the session token is later presented for authorization, the system reconstructs the structured data object from the received token, recomputes the token hash using the same hashing circuitry, and retrieves the previously stored hash from the audit state. A comparison unit then performs a bit-level comparison between the recomputed hash and the stored reference. If the two hash values match exactly, the system confirms that the session token has not been altered since its generation and that it corresponds to the original session parameters. Conversely, if any discrepancy is detected, the control logic immediately rejects the token, indicating potential tampering, unauthorized modification, or invalid reconstruction. For instance, if an attempt is made to extend the validity interval or modify the nonce reference to reuse the token beyond its intended scope, the recomputed hash will differ from the stored value, resulting in rejection.

This arrangement ensures that the session token is not only authenticated through signing but also continuously verifiable through hash-based comparison against an immutable audit reference. The combination of deterministic encoding, cryptographic hashing, and secure signing establishes a robust mechanism for preserving token integrity, preventing unauthorized reuse or alteration, and maintaining consistent validation across distributed processing nodes without reliance on external state reconstruction.

In an embodiment, computing the token quantity further comprises normalizing the energy value into a standardized unit, applying the tokenization factor using fixed-point arithmetic with a predefined precision parameter, generating an intermediate token value, performing truncation of the intermediate token value based on the predefined precision parameter, and storing the truncated token value as the token quantity in the renewable token state. Upon receiving a validated energy value from the generation evidence, the processor first routes the value through a normalization stage in which a predefined scaling factor, stored in a configuration register, converts the incoming measurement into a standardized internal unit. This normalization ensures that energy values originating from different metering devices or measurement standards are harmonized into a consistent representation before further processing.

Following normalization, the processor applies the tokenization factor using a fixed-point arithmetic unit configured with a predefined precision parameter. This precision parameter defines the number of fractional bits retained during computation and is enforced through dedicated precision control registers that govern arithmetic operations. The multiplication of the normalized energy value with the tokenization factor produces an intermediate token value stored within an accumulator register. For example, when handling fine-grained energy contributions such as fractional kilowatt-hours, the fixed-point unit preserves these fractional components up to the configured precision, ensuring that small but valid energy contributions are accurately represented prior to final conversion.

The intermediate token value is then subjected to a truncation operation executed by a truncation control unit that removes fractional components beyond the predefined precision parameter. Unlike rounding-based approaches, this truncation process ensures that the resulting token value does not exceed the computed entitlement, thereby enforcing a conservative allocation model. The truncation is implemented through bit-level masking or shifting operations that discard lower-order bits corresponding to fractional precision beyond the allowed limit. For instance, if the intermediate value includes fractional units below the permitted precision, these are systematically removed to produce a stable and bounded token quantity. The truncated token value is subsequently written into the renewable token state memory along with references to the originating generation evidence. This stored value represents the final token quantity that will be used in subsequent matching and settlement operations. By relying on fixed-point arithmetic and deterministic truncation rather than floating-point computation or variable rounding behavior, the system ensures that identical input conditions always produce identical token quantities, regardless of the processing node or execution timing. This approach provides a consistent and verifiable conversion mechanism in which energy measurements are translated into token units without ambiguity or over-allocation.

In an embodiment, locking the payment amount and the token quantity comprises generating a payment lock identifier and a token lock identifier, associating the payment lock identifier and the token lock identifier with the settlement record, storing a lock state indicator in the settlement state, and preventing modification of the payment amount and the token quantity by rejecting any state update request that does not include both the payment lock identifier and the token lock identifier. When a settlement record is created following the matching operation, the processor invokes a lock identifier generation routine in which a payment lock identifier and a token lock identifier are produced using a hardware-backed identifier generator, such as a monotonic sequence generator combined with session-specific parameters. These identifiers are unique for each settlement instance and are immediately embedded into the settlement record structure, forming a binding reference between the locked resources and the transaction context. The processor then writes a lock state indicator into a dedicated field within the settlement state memory, signaling that the associated payment amount and token quantity are in a protected condition. This indicator is maintained in a control register that is continuously monitored by the system's state management logic. Alongside this, the generated lock identifiers are stored in indexed memory locations linked to the settlement record, enabling rapid retrieval and verification during subsequent access attempts.

Any request to modify or release the payment amount or token quantity is routed through an access-validation unit that enforces a strict requirement for both lock identifiers to be presented as part of the request. The validation unit performs a comparison between the supplied identifiers and the stored identifiers within the settlement state. Only when both the payment lock identifier and the token lock identifier match exactly with the stored values does the system permit the requested operation to proceed. For example, if an update request includes only one of the identifiers or presents mismatched values, the comparison logic immediately rejects the request, preventing partial or unauthorized modification of the locked resources. This dual-identifier enforcement ensures that neither the payment amount nor the token quantity can be independently altered, thereby maintaining synchronization between financial and energy assets throughout the settlement lifecycle. In a practical scenario, even if concurrent processes attempt to access or update the same settlement entry, the absence of both valid identifiers in the request prevents any unintended state change, ensuring that all modifications are explicitly authorized and contextually bound to the original transaction. The lock state remains active until a controlled release condition-such as completion of validation checks and execution of the final state transition—is satisfied. At that point, the system verifies the identifiers once more and clears the lock state indicator in a coordinated operation, allowing both resources to be updated or transferred simultaneously. This arrangement ensures that all state modifications are gated by strict identifier-based validation, eliminating the possibility of inconsistent updates, enforcing transactional integrity, and maintaining a consistent association between locked assets and their corresponding settlement record.

In an embodiment, validating correspondence between the meter-evidence hash and the signed meter record comprises computing a first hash over the signed meter record, concatenating the first hash with a session identifier to form a concatenated value, computing a second hash over the concatenated value, and comparing the second hash with a stored hash reference in the permissioned consortium network.

In this embodiment, the validation of correspondence between the meter-evidence hash and the signed meter record is strengthened through a two-stage hashing process implemented using dedicated hashing circuitry, concatenation registers, and comparison logic, thereby ensuring that the integrity verification is not only data-dependent but also bound to the specific session context. When the signed meter record is received, the processor first routes the record into a hashing engine that computes a first hash value representing the exact content of the meter record. This operation produces a fixed-length digest that is highly sensitive to any modification in the underlying data, ensuring that even minor alterations in the meter record result in a different hash output.

The resulting first hash is then transferred into a concatenation buffer where it is combined with a session identifier retrieved from the session record maintained in memory. This concatenation is performed in a predefined sequence using register-level operations, ensuring that the combined value is constructed deterministically across all processing instances. By incorporating the session identifier into the concatenated value, the system effectively binds the integrity check to the specific charging session, preventing reuse of a valid meter record across different sessions.

The concatenated value is subsequently processed by the same or a separate hashing engine to compute a second hash value. This second hash represents a composite digest that encapsulates both the original meter data and its association with the session identifier. The processor then retrieves a stored hash reference from the permissioned consortium network, which corresponds to the expected composite hash generated at the time the meter record was initially anchored or recorded.

A comparison unit performs a bit-level comparison between the computed second hash and the retrieved hash reference. If the values match exactly, the system confirms that the signed meter record is both unaltered and correctly associated with the intended session. For example, if an attempt is made to reuse a previously valid meter record in a different session, the session identifier used in the concatenation step will differ, resulting in a different second hash and causing the comparison to fail. Similarly, any modification to the meter record itself will alter the first hash, propagating through to the second hash and leading to rejection.

If a mismatch is detected at any stage, the control logic immediately halts further processing of the delivery evidence and maintains the associated escrow entries in a locked state. Conversely, a successful match allows the system to proceed with subsequent validation and settlement steps. This two-level hashing approach ensures that integrity verification is robust against both data tampering and cross-session replay, while the use of deterministic concatenation and hashing operations guarantees consistent validation outcomes across distributed nodes within the consortium network. In an embodiment, executing the atomic state transition comprises generating a transaction input sequence including the payment amount, the token quantity, the delivered-energy value, and the meter-evidence hash, computing a transaction digest by applying a cryptographic hash function to the transaction input sequence, submitting the transaction digest for validation by the permissioned consortium network, and updating the settlement state and the audit state in a single write operation only upon validation of the transaction digest.

In this embodiment, the atomic state transition is implemented through a structured transaction-digest workflow that combines deterministic data assembly, cryptographic hashing, network-level validation, and synchronized state update control to ensure that settlement completion occurs only after full verification of all contributing parameters. Once the system determines that prerequisite conditions such as delivery integrity and deviation compliance are satisfied, the processor constructs a transaction input sequence by aggregating the payment amount, the token quantity, the delivered-energy value, and the meter-evidence hash into a contiguous data structure within a transaction buffer. Each component is placed at a predefined offset using register-level mapping so that the sequence can be reconstructed identically across all participating nodes. This transaction input sequence is then supplied to a cryptographic hashing engine that computes a transaction digest representing the combined state of all settlement-critical parameters. The hashing operation ensures that any alteration in any of the included values-whether financial, energy-related, or integrity-linked-produces a distinct digest, thereby making the digest a compact and reliable representation of the entire transaction context. For example, even a minor modification in the delivered-energy value or the associated meter-evidence hash would result in a different digest, preventing unauthorized or inconsistent transaction representations from being accepted.

The computed transaction digest is subsequently transmitted through a network interface to participating nodes within the permissioned consortium network for validation. Each node independently reconstructs or verifies the digest against its locally maintained state and validation rules, ensuring that the transaction complies with all previously established conditions such as escrow locks, session integrity, and evidence consistency. The validation responses are processed by the control logic, which permits progression only when the required consensus condition is satisfied, thereby preventing unilateral or inconsistent state updates. Upon successful validation of the transaction digest, the processor activates a commit control unit that performs a synchronized write operation across both the settlement state and the audit state. This write operation is executed as a single coordinated action in which all relevant fields—including release of escrowed payment and token quantities, update of ownership records, and recording of the finalized transaction reference—are updated simultaneously. The control unit ensures that no intermediate state is exposed during this process; if any part of the write operation cannot be completed, the system retains the previous state and aborts the transition.

This arrangement ensures that the transition from a pending settlement to a finalized state is governed by a verifiable digest that encapsulates all critical parameters and is validated across the consortium network before any state change occurs. The use of a single synchronized write operation guarantees that financial and energy asset transfers remain consistent and indivisible, while the reliance on digest-based validation prevents discrepancies arising from partial updates, tampering, or inconsistent data propagation across distributed nodes. In an embodiment, validating the nonce-bound credential proof further comprises maintaining a bounded nonce-cache structure indexed by the station identifier and the session pseudonym, storing accepted nonce values in the bounded nonce-cache structure along with corresponding temporal values, evicting stored nonce values based on a least-recently-used sequence when a storage threshold is reached, and rejecting the nonce-bound credential proof when the cryptographic challenge nonce matches any nonce value retained within the bounded nonce-cache structure.

In this embodiment, the validation process is extended through a bounded nonce-cache mechanism implemented using indexed memory arrays, cache-management logic, and comparison circuitry to ensure that previously accepted authentication artifacts cannot be reused within or across active sessions. When a nonce-bound credential proof is successfully verified, the processor writes the corresponding cryptographic challenge nonce into a nonce-cache structure that is physically organized as a lookup table indexed by a combination of the station identifier and the session pseudonym. Each cache entry includes the nonce value along with an associated temporal value obtained from the system clock, enabling both identification and aging of stored entries.

The nonce-cache is maintained as a bounded structure with a predefined storage capacity enforced by hardware-controlled thresholds. As new nonce values are inserted, the cache-management unit monitors the occupancy level and triggers an eviction routine when the storage threshold is reached. This eviction is performed using a least-recently-used sequencing mechanism implemented through ordering registers or pointer-based tracking, where entries that have not been accessed or updated for the longest duration are selected for removal. For example, in a high-throughput charging environment where multiple authentication events occur in rapid succession, the cache ensures that only the most recent and relevant nonce values are retained while older entries are systematically purged to maintain efficient memory utilization.

During validation of a newly received nonce-bound credential proof, the processor routes the incoming nonce value to a comparison unit that performs a lookup operation within the nonce-cache structure. This lookup is executed using indexed addressing based on the station identifier and session pseudonym, followed by a parallel or sequential comparison against stored nonce values. If a match is detected—indicating that the same nonce has already been accepted and recorded—the control logic immediately rejects the credential proof, even if all other validation conditions such as signature correctness and temporal validity are satisfied. This ensures that replay attempts using previously accepted nonces are effectively blocked. The inclusion of temporal values within each cache entry further supports efficient cache maintenance and validation decisions. For instance, entries that fall outside a defined retention interval can be deprioritized or removed during eviction, ensuring that the cache reflects only recent authentication activity relevant to current sessions. Additionally, the use of bounded storage with controlled eviction prevents unbounded growth of memory usage, maintaining predictable performance and resource allocation within the system.

Through this arrangement, the nonce-cache mechanism introduces an additional layer of protection against replay and duplication by enforcing strict single-use semantics for each nonce. The combination of indexed storage, least-recently-used eviction, and real-time comparison ensures that authentication remains both secure and scalable, preventing reuse of credential proofs while maintaining efficient operation in environments with frequent and concurrent session initiations. In an embodiment, generating the session token further comprises associating the session token with a state-transition constraint table stored in the audit state, the state-transition constraint table defining permissible transitions between session states including admitted, charging, evidence-pending, finalized, and disputed, and validating each state transition by comparing a requested state transition with entries in the state-transition constraint table prior to updating the session record.

In this embodiment, the session token is extended to function not only as an authorization artifact but also as a control reference for governing permissible progression of the charging session through predefined operational states. Once the session token is generated, the processor establishes an association between the token and a state-transition constraint table maintained within the audit-state memory. This table is physically organized as a structured data matrix or indexed lookup structure in which each entry defines a valid source state and its corresponding allowable destination states. The defined states include admitted, charging, evidence-pending, finalized, and disputed, each representing a distinct phase in the lifecycle of the charging session. The association is achieved by linking the token identifier to the location of the state-transition constraint table within memory, enabling rapid retrieval of the constraint definitions whenever a state change is requested. When the system receives a request to transition the session from one state to another—such as from charging to evidence-pending after completion of energy delivery—the processor retrieves the current session state from the session record and the requested destination state from the incoming control signal. These values are supplied to a validation unit that compares the requested transition against the entries in the constraint table. The comparison is executed using deterministic lookup logic, where the current state is used as an index to identify all permissible next states, and the requested state is checked for membership within this set. For example, a transition from admitted directly to finalized would not be present in the constraint table and would therefore be rejected by the validation logic, preventing bypassing of intermediate stages such as charging or evidence verification. Conversely, a transition from charging to evidence-pending would match a valid entry and be permitted to proceed.

If the requested transition satisfies the constraint conditions, the processor updates the session record to reflect the new state, ensuring that the progression is recorded in both the session memory and the audit state. If the transition is not permitted, the control logic blocks the update and may record an invalid transition attempt in the audit state for traceability. This enforcement ensures that all session progressions follow a controlled and predefined sequence, eliminating the possibility of inconsistent or unauthorized state changes. By embedding state-transition constraints within the audit-linked structure and binding them to the session token, the system ensures that state progression is both verifiable and consistently enforced across all processing nodes. The use of structured constraint tables and hardware-supported comparison logic provides a reliable mechanism for maintaining orderly session flow, preventing premature or invalid transitions, and ensuring that each stage of the charging and settlement process is completed in the correct sequence before advancing to the next phase.

In an embodiment, executing the matching operation further comprises constructing a deterministic ordering sequence of available token quantities by computing a composite ordering value for each token quantity using a weighted combination of a price parameter, a timestamp parameter, and a source identifier, sorting the available token quantities based on the composite ordering value, and selecting token quantities sequentially according to the sorted ordering sequence. In this embodiment, the matching operation is further refined through a deterministic ordering mechanism implemented using composite scoring logic, normalization circuitry, and stable sorting units to ensure that selection of token quantities remains consistent and reproducible across all execution environments. When available token quantities are retrieved from the renewable token state, the processor maps each token entry into a structured buffer where associated attributes—including a price parameter, a timestamp parameter, and a source identifier—are loaded into dedicated registers. These parameters are then supplied to a composite scoring unit that computes an ordering value for each token entry using a weighted combination defined in configuration registers.

The weighted combination is executed using fixed-point arithmetic logic, where each parameter is first normalized to a comparable scale through scaling factors and then multiplied by its corresponding weight. For instance, the price parameter may be inversely weighted to prioritize lower-cost tokens, the timestamp parameter may be adjusted to favor more recent or time-sensitive generation events, and the source identifier may introduce a bias based on predefined policy preferences such as prioritizing certain energy sources or providers. The resulting values are accumulated within an arithmetic unit to produce a composite ordering value that uniquely represents the relative priority of each token entry. Once all composite ordering values are computed, the processor transfers the token entries to a sorting module configured to perform deterministic ordering based on the computed values. This sorting module employs a stable comparison sequence, ensuring that entries with identical composite values are further ordered using secondary attributes such as timestamp or identifier values to avoid ambiguity. The deterministic nature of this sorting process ensures that identical input conditions always produce the same ordered sequence, regardless of execution timing or processing node.

Following sorting, the processor initiates a sequential selection process in which token quantities are drawn from the ordered sequence in priority order. An accumulator register tracks the cumulative quantity of selected tokens, and the selection continues iteratively until the requested energy quantity is satisfied. For example, if the requested energy quantity cannot be fulfilled by a single token entry, multiple entries are selected in sequence, with each selection contributing incrementally to the total until the requirement is met within defined limits. Each selected token entry is recorded along with its associated parameters in a settlement buffer, forming a traceable linkage between the ordering decision and the final allocation. This ensures that the basis for selection—derived from the composite ordering value—is preserved for subsequent verification or auditing. By combining weighted parameter evaluation with deterministic sorting and sequential selection, this embodiment ensures that token matching is governed by a transparent and reproducible prioritization mechanism, eliminating variability in allocation decisions and enabling consistent behavior across distributed processing nodes.

In an embodiment, receiving the signed delivery evidence further comprises generating a sequence of intermediate metering values during the charging session, computing a cumulative energy value from the sequence of intermediate metering values, comparing the cumulative energy value with the delivered-energy value included in the signed delivery evidence, and rejecting the signed delivery evidence when a deviation between the cumulative energy value and the delivered-energy value exceeds a predefined deviation threshold.

In this embodiment, the validation of signed delivery evidence is reinforced through continuous in-session measurement tracking and aggregation using metering interface circuitry, accumulation registers, and deviation analysis logic to ensure that the final reported delivery is consistent with the actual energy flow observed during the charging process. As the charging session progresses, the system acquires a sequence of intermediate metering values from the metering device through a data acquisition interface, where each value represents energy delivered over a discrete time interval. These values are captured at predefined sampling intervals and stored sequentially in a buffer associated with the active session record. The processor routes each incoming intermediate value to an accumulation unit that incrementally computes a cumulative energy value by summing the sequence using fixed-width arithmetic operations. This accumulation is maintained in a dedicated register that is continuously updated as new metering values are received, thereby forming a running total of energy delivered throughout the session. For example, in a charging session spanning several minutes, each sampled interval contributes to the cumulative total, ensuring that the system maintains an independent and continuously updated representation of delivered energy rather than relying solely on a final reported value.

Upon receipt of the signed delivery evidence at the end of the session, which includes a delivered-energy value reported by the metering device, the processor retrieves the cumulative energy value from the accumulation register and supplies both values to a comparison unit. This unit computes a deviation value representing the difference between the independently accumulated energy and the reported delivered-energy value. The deviation is then evaluated against a predefined deviation threshold stored in the settlement state, which accounts for acceptable measurement tolerances arising from sampling resolution or minor system variations.

If the computed deviation exceeds the predefined threshold, the control logic interprets this as an inconsistency between the observed energy delivery and the reported value. In such a case, the system rejects the signed delivery evidence and prevents further progression toward settlement, thereby ensuring that inaccurate or manipulated delivery data does not influence payment or token release. For instance, if a compromised metering device reports an inflated delivered-energy value that does not align with the cumulative measurements captured during the session, the discrepancy is detected through this comparison and the evidence is invalidated. By integrating real-time accumulation of intermediate metering values with end-of-session validation, this embodiment ensures that delivery verification is grounded in independently observed data rather than relying solely on externally reported values. The use of continuous measurement tracking and threshold-based comparison enhances reliability of energy accounting, detects inconsistencies arising from device faults or tampering, and ensures that settlement decisions are based on verifiable and internally corroborated energy delivery information.

In an embodiment, validating the nonce-bound credential proof further comprises maintaining, within the identity registry state, a bounded nonce-cache data structure indexed by a combination of the station identifier and the session pseudonym, storing each accepted cryptographic challenge nonce in the bounded nonce-cache data structure together with an associated timestamp and a usage flag, updating the usage flag upon successful verification of the nonce-bound credential proof, evicting entries from the bounded nonce-cache data structure based on a least-recently-used ordering when a predefined storage threshold is exceeded, and rejecting a subsequently received nonce-bound credential proof when the cryptographic challenge nonce matches any stored nonce value within the bounded nonce-cache data structure that has a timestamp within a predefined retention interval. When a nonce-bound credential proof is successfully verified, the processor stores the corresponding cryptographic challenge nonce in the nonce-cache data structure, where entries are indexed using a composite key formed from the station identifier and the session pseudonym. This indexing approach ensures that nonce tracking is context-specific, preventing cross-session ambiguity and enabling precise lookup operations during subsequent validations.

Each cache entry is structured to include the nonce value, an associated timestamp derived from the system clock, and a usage flag maintained in a dedicated status field. The timestamp provides temporal context for each stored nonce, while the usage flag is updated immediately upon successful verification to indicate that the nonce has been consumed in a valid authentication sequence. For example, when a credential proof is accepted, the corresponding nonce entry is marked as used, ensuring that any further attempt to reuse the same nonce can be detected even if it occurs within a short time window. The nonce-cache is maintained as a bounded structure with a predefined storage capacity enforced by threshold registers within the identity registry. As new entries are inserted, the cache-management unit monitors the occupancy level and initiates an eviction process when the threshold is exceeded. This eviction is governed by a least-recently-used ordering mechanism implemented through access-tracking registers or pointer-based sequencing, where entries that have not been accessed or updated for the longest duration are selected for removal. In addition, the system considers the timestamp associated with each entry, allowing prioritization of older entries for eviction while retaining more recent nonce values that are still within the relevant operational window.

During validation of a newly received nonce-bound credential proof, the processor performs a lookup operation within the nonce-cache using the station identifier and session pseudonym as indices. The retrieved entries are compared against the incoming nonce value using bit-level comparison logic. If a matching nonce is found and its associated timestamp falls within a predefined retention interval stored in configuration registers, the system identifies this as a reuse attempt and rejects the credential proof immediately. This rejection occurs regardless of the correctness of other parameters such as signature validity or temporal bounds, thereby ensuring that nonce reuse is categorically prevented. For instance, if an attacker attempts to replay a previously accepted credential proof within the retention interval, the presence of the nonce in the cache with an active usage flag and valid timestamp will trigger rejection, effectively blocking the replay attempt. Conversely, nonce values that fall outside the retention interval or have been evicted due to least-recently-used policies are no longer considered for rejection, ensuring that the cache remains efficient and focused on recent authentication activity.

This arrangement provides a robust mechanism for preventing replay and duplication by combining context-aware indexing, temporal tracking, and bounded storage with controlled eviction.

In an embodiment, generating the session token further comprises constructing a session-control record stored in the audit state, the session-control record including a state-transition constraint table defining permissible transitions between session states, encoding the state-transition constraint table as a structured data sequence including permitted source states and permitted destination states, validating each requested state transition by retrieving the session-control record and comparing the requested transition against the state-transition constraint table, and preventing progression of the session record to a subsequent state when the requested transition is not represented within the state-transition constraint table. Upon successful admission of a session, the processor constructs the session-control record within the audit-state memory by assembling a state-transition constraint table in a structured data format. This table is encoded as a sequence of entries, each entry defining a permissible mapping between a source state and one or more corresponding destination states. The encoding is performed using fixed field positions and identifiers so that each state and its allowable transitions are represented in a deterministic and machine-interpretable form. For example, an entry may specify that a session in an admitted state is permitted to transition only to a charging state, while another entry defines that a charging state may progress to an evidence-pending state but not directly to a finalized state.

The constructed session-control record is linked to the session token by embedding a reference pointer or identifier within the token structure, enabling rapid retrieval of the constraint table during runtime. When a state transition request is generated—such as transitioning from charging to evidence-pending after completion of energy delivery—the processor retrieves the current session state from the session record and the requested destination state from the control input. These values are supplied to a validation unit that accesses the session-control record from the audit state and scans the encoded constraint table to determine whether the requested transition is explicitly defined.

The comparison process is executed using deterministic lookup logic in which the current state is used to index the relevant entries in the constraint table, and the requested destination state is checked against the permitted set associated with that source state. This ensures that only transitions explicitly encoded in the table are allowed to proceed. For instance, if a request attempts to move the session directly from admitted to finalized without passing through intermediate stages such as charging and evidence validation, the absence of such a mapping in the constraint table results in immediate rejection by the control logic. If the requested transition is validated as permissible, the processor updates the session record to reflect the new state and records the transition in the audit state for traceability. Conversely, if the transition is not represented within the constraint table, the system blocks the update and prevents progression of the session record, thereby maintaining the integrity of the defined state sequence. This prevention mechanism ensures that no unauthorized or out-of-order transitions can occur, even under concurrent or externally triggered requests. By encoding the permissible state transitions within a structured session-control record and enforcing validation through hardware-supported lookup and comparison operations, the system ensures that session progression remains orderly, verifiable, and consistent across all processing nodes. This approach eliminates ambiguity in state management, prevents bypassing of critical validation stages, and ensures that each phase of the charging and settlement lifecycle is completed in the correct sequence before advancement. In an embodiment, executing the matching operation further comprises constructing, within the settlement state, an ordered token-selection structure including a plurality of candidate token entries, computing for each candidate token entry a composite ordering value derived from a weighted combination of a price parameter, a timestamp parameter, and a source identifier, normalizing the composite ordering value using a scaling sequence to ensure comparable magnitude across candidate token entries, sorting the candidate token entries based on the normalized composite ordering value using a deterministic sorting sequence, and selecting token quantities sequentially from the sorted candidate token entries until the requested energy quantity is satisfied. When the settlement stage is initiated, the processor constructs an ordered token-selection structure within the settlement state by retrieving all eligible token entries from the renewable token repository and loading them into a dedicated memory buffer. Each candidate entry includes associated attributes such as a price parameter, a timestamp parameter reflecting availability or generation time, and a source identifier representing origin or classification.

The processor then computes a composite ordering value for each candidate entry using a weighted combination of these attributes. This computation is performed by arithmetic logic units that apply predefined weights stored in configuration registers, allowing the system to emphasize cost efficiency, recency, or source preference as required. To ensure that differences in scale among the parameters do not distort the ordering, the computed composite values are passed through a normalization stage implemented using scaling sequence s. These scaling sequence s adjust the magnitude of each composite value to a common range, enabling fair comparison across all candidate entries regardless of the original parameter ranges.

Once normalized, the candidate entries are processed by a sorting module configured to apply a deterministic sorting sequence. This module uses a stable comparison sequence that orders entries strictly based on their normalized composite values, with secondary comparison conditions-such as timestamp or identifier ordering-applied when equal values are encountered. This ensures that identical input conditions always yield the same sorted sequence, eliminating variability in selection outcomes across distributed nodes. Following sorting, the processor initiates a sequential selection process in which token quantities are drawn from the ordered candidate entries in priority order. An accumulator register tracks the cumulative quantity of selected tokens, and the processor continues selecting entries until the requested energy quantity is satisfied. For example, if the requirement cannot be met by a single candidate entry, multiple entries are combined in sequence, with each contributing incrementally to the total until the target is reached within permissible limits.

Each selected token entry, along with its associated parameters and contribution to the total allocation, is recorded within the settlement record, ensuring that the selection process remains traceable and verifiable. This arrangement ensures that token allocation is governed by a normalized and weighted prioritization mechanism, producing consistent and transparent outcomes. The integration of normalization with deterministic sorting prevents bias arising from parameter scale differences, while the sequential selection process ensures efficient utilization of available token resources without over-allocation or ambiguity in selection decisions.

In an embodiment, normalizing the composite ordering value using the scaling sequence comprises converting the composite ordering value associated with each candidate token entry into a normalized composite ordering value by applying a scaling factor corresponding to at least one of a price parameter range, a time parameter range, or a policy-derived weighting factor range such that comparable magnitude is ensured across candidate token entries, and wherein sorting the candidate token entries based on the normalized composite ordering value using the deterministic sorting sequence comprises performing successive comparison operations between normalized composite ordering values associated with the candidate token entries, arranging the candidate token entries according to comparison results generated from the successive comparison operations, resolving equivalent normalized composite ordering values using at least one secondary parameter including a timestamp value or a token identifier such that identical input candidate token entries produce an identical sorted candidate token entry sequence, and selecting token quantities sequentially from the sorted candidate token entries until the requested energy quantity is satisfied. Initially, the processor retrieves the composite ordering value associated with each candidate token entry from the renewable token state, wherein the composite ordering value is generated from multiple operational parameters including a price parameter, a time parameter, and a policy-derived weighting factor. Because these parameters may exist in substantially different numerical ranges, direct comparison between composite ordering values may result in disproportionate weighting of one parameter over another. To address this condition, the processor accesses a scaling register storing scaling factors associated with each parameter range and converts the composite ordering value into a normalized composite ordering value through a sequence of fixed-point scaling operations. For example, a candidate token entry associated with a lower energy price but an older generation timestamp may initially possess a composite ordering value numerically larger than a more recent token entry due solely to the larger magnitude of the pricing parameter. During normalization, the scaling factors proportionally compress or expand the respective parameter ranges so that the resulting normalized composite ordering values remain directly comparable irrespective of original parameter magnitude. The scaling operations are executed using fixed-point arithmetic circuitry configured with predefined precision parameters stored within configuration registers, thereby preventing computational drift and eliminating inconsistencies arising from floating-point representation differences across distributed processing nodes. The normalized composite ordering values are thereafter written into an ordered candidate structure maintained in high-speed session memory and indexed according to corresponding candidate token identifiers. By ensuring that all candidate token entries are transformed into a comparable numerical domain prior to ordering, the system prevents preferential bias toward token entries having disproportionately larger parameter magnitudes and enables stable allocation behavior even when renewable token sources originate from geographically distributed generation environments with differing pricing structures and generation intervals. In a practical charging scenario involving renewable-energy tokens generated from solar installations during different tariff windows, the normalization sequence ensures that low-cost but temporally stale token entries do not unintentionally dominate the selection process over recently generated tokens intended for time-sensitive settlement conditions. The resulting arrangement improves consistency of token allocation, enhances reproducibility of settlement outcomes across consortium nodes, and reduces divergence in token selection behavior during high-throughput charging operations involving simultaneous charging-session requests.

In an embodiment, sorting the candidate token entries based on the normalized composite ordering value using the deterministic sorting sequence is implemented through coordinated operation of comparison circuitry, ordered memory structures, sequential evaluation registers, and cumulative allocation logic configured to generate a reproducible arrangement of candidate token entries prior to execution of renewable-energy settlement. After generation of the normalized composite ordering values, the processor loads the candidate token entries into a sorting buffer in which each entry includes the normalized composite ordering value together with associated timestamp values, token identifiers, pricing metadata, and energy quantity values. The processor then initiates successive comparison operations between normalized composite ordering values using comparison circuitry configured to evaluate adjacent or indexed candidate token entries according to a predefined comparison sequence retained within control registers. Whenever a first candidate token entry possesses a normalized composite ordering value greater than a second candidate token entry according to the comparison condition, the positions of the entries are exchanged within the sorting buffer until the candidate token entries converge into a reproducible ordered sequence. In circumstances where multiple candidate token entries possess identical normalized composite ordering values, the processor invokes a secondary comparison sequence using timestamp values or token identifiers to eliminate ambiguity in ordering. For example, when two renewable-energy token entries are generated under identical pricing and weighting conditions, the system may prioritize the token entry having an earlier generation timestamp or lower token identifier value, thereby ensuring that repeated execution of the same matching operation across separate consortium nodes produces an identical sorted candidate token entry sequence. This deterministic ordering mechanism prevents divergence in settlement computation between distributed processing nodes and eliminates inconsistent token selection outcomes that could otherwise arise from arbitrary memory ordering or asynchronous processing behavior. Once ordering is completed, the processor sequentially retrieves token quantities from the sorted candidate token entries while maintaining a cumulative allocation value within an accumulator register. The accumulator register is continuously updated after each token selection operation, and comparison circuitry evaluates whether the cumulative allocation value satisfies the requested energy quantity associated with the charging session. For instance, when a charging request requires a defined quantity of renewable energy exceeding the quantity available in a single token entry, the processor sequentially combines multiple sorted candidate token entries until the requested energy quantity is achieved within a predefined tolerance interval. Because the selection sequence is derived from a deterministic ordering arrangement, every participating consortium node independently arrives at an identical token allocation structure when processing identical input data, thereby improving synchronization of settlement records and reducing risk of conflicting escrow states. The arrangement additionally minimizes processing uncertainty during concurrent charging operations, enables stable token prioritization under fluctuating pricing conditions, and maintains predictable allocation behavior during high-frequency settlement execution involving large-scale renewable-energy token pools.

In an embodiment, receiving the signed delivery evidence further comprises acquiring a sequence of intermediate metering values during the charging session, storing the sequence of intermediate metering values in association with the session record, computing a cumulative energy value by aggregating the sequence of intermediate metering values using an accumulation function, comparing the cumulative energy value with the delivered-energy value included in the signed delivery evidence to determine a deviation value, and rejecting the signed delivery evidence when the deviation value exceeds a predefined deviation threshold stored in the settlement state.

In this embodiment, validation of the signed delivery evidence is reinforced by maintaining an independently derived record of energy delivery throughout the charging session using metering acquisition circuitry, session-linked storage buffers, and accumulation logic. As the charging process progresses, the system continuously acquires intermediate metering values from the metering interface at defined sampling intervals. Each acquired value represents the incremental energy delivered during a specific time slice and is written into a sequential buffer that is directly associated with the session record in memory. This association ensures that all intermediate measurements are contextually bound to the active charging session and can be retrieved in an ordered manner for subsequent processing.

The processor routes the stored sequence of intermediate metering values to an accumulation unit that computes a cumulative energy value by iteratively aggregating the sequence using a predefined accumulation function. This function is executed through fixed-width arithmetic circuitry, ensuring that each incremental value contributes accurately to a running total maintained in a dedicated accumulation register. For example, during a charging session with periodic sampling, each recorded increment is added to the cumulative total, resulting in a continuously updated representation of actual energy delivered as observed by the system, independent of any final reported value.

Upon receipt of the signed delivery evidence at the conclusion of the session, the processor extracts the delivered-energy value included in the evidence and retrieves the cumulative energy value from the accumulation register. Both values are supplied to a comparison unit that computes a deviation value representing the difference between the independently accumulated energy and the reported delivered-energy value. This deviation value is then evaluated against a predefined deviation threshold stored in the settlement state, where the threshold reflects acceptable tolerances due to measurement resolution or minor operational variations.

If the deviation value exceeds the predefined threshold, the control logic determines that the reported delivery does not align with the observed sequence of intermediate measurements and rejects the signed delivery evidence. This rejection prevents progression to settlement and maintains any associated escrow entries in a protected state, thereby ensuring that inconsistent or manipulated delivery data cannot influence financial or token transfers. For instance, if a metering device attempts to report a higher delivered-energy value than what was actually accumulated during the session, the discrepancy is detected through this comparison and the evidence is invalidated.

Conversely, when the deviation value falls within the acceptable threshold, the system accepts the signed delivery evidence as consistent with the independently tracked energy delivery and allows subsequent settlement operations to proceed. The deviation value and the outcome of the comparison may also be recorded in the audit state, providing a verifiable trace of the validation process.

In an embodiment, executing the atomic state transition further comprises generating a pre-commit record including the payment amount, the token quantity, the delivered-energy value, and the meter-evidence hash, computing a pre-commit hash by applying a cryptographic hash function over the pre-commit record, storing the pre-commit hash in the audit state, validating the pre-commit hash against a consensus validation process within the permissioned consortium network, and completing the atomic state transition only after successful validation of the pre-commit hash, such that partial updates to the settlement state are prevented.

In this embodiment, the atomic state transition is preceded by a controlled pre-commit phase that introduces an intermediate integrity checkpoint using structured record assembly, hashing circuitry, audit-state storage, and network validation interfaces to ensure that all settlement parameters are verified before any state modification is finalized. Once the system determines that prerequisite validations have been satisfied, the processor constructs a pre-commit record by aggregating the payment amount, the token quantity, the delivered-energy value, and the meter-evidence hash into a contiguous data structure within a pre-commit buffer. Each element is mapped to predefined positions within the buffer, ensuring that the record is encoded deterministically and can be reconstructed identically across participating nodes. The assembled pre-commit record is then processed by a cryptographic hashing engine that computes a pre-commit hash representing the complete state of the transaction at this intermediate stage. This hash serves as a compact integrity representation of all critical parameters, such that any alteration in the pre-commit record—whether in financial values, energy measurements, or integrity references—results in a different hash output. For example, if an attempt is made to modify the token quantity or substitute a different meter-evidence hash, the recomputed hash would diverge from the original, enabling immediate detection.

The computed pre-commit hash is stored in the audit-state memory in association with the session and settlement record, forming a persistent reference that captures the exact pre-finalization state of the transaction. This stored value is then transmitted through a network interface to participating nodes within the permissioned consortium network, where it is subjected to a consensus validation process. Each node independently verifies the pre-commit hash against its locally reconstructed or expected values, ensuring that the transaction parameters are consistent and acceptable across the distributed system. The processor monitors the validation responses and proceeds only when the required consensus condition is satisfied. Upon successful validation, a commit control unit is activated to execute the atomic state transition, wherein updates to the settlement state and audit state are performed in a single synchronized operation. This includes releasing escrowed payment and token quantities, updating ownership or allocation records, and recording the finalized transaction reference. The synchronization ensures that all related state variables are updated simultaneously, preventing any intermediate condition in which only a subset of the transaction parameters is applied.

If the pre-commit hash fails validation or if consensus is not achieved, the system aborts the transition and retains the existing state, including maintaining escrow locks and preventing any release of resources. This ensures that no partial or inconsistent updates occur under any circumstances. By introducing the pre-commit hash as a validated checkpoint prior to final state transition, the system establishes a robust safeguard against inconsistent data propagation, unauthorized modifications, or incomplete updates, ensuring that settlement finalization occurs only after full agreement on an immutable representation of the transaction state.

In an embodiment, storing the signed meter records further comprises segmenting each signed meter record into a plurality of data fragments, encrypting each data fragment using an encryption key associated with the consortium control system, generating a fragment hash for each encrypted data fragment, computing a composite hash by applying a cryptographic hash function over a concatenation of the fragment hashes, storing the encrypted data fragments in distributed storage external to the permissioned consortium network, and storing the composite hash within the permissioned consortium network to enable verification of integrity of the segmented signed meter record.

Each generated fragment is then passed to an encryption engine that applies a cryptographic transformation using a key retained within a secure key storage module of the consortium control system. The encryption operation is executed independently for each fragment, ensuring that even if one fragment is accessed externally, it cannot reveal meaningful information about the overall record or other fragments. For example, large meter records containing detailed consumption logs can be securely partitioned and protected without requiring the entire dataset to be handled as a single unit. Following encryption, each encrypted fragment is processed by a hashing module to generate a fragment hash. These fragment hashes serve as individual integrity markers for each fragment, capturing the exact encrypted content at the time of storage. The processor then concatenates the sequence of fragment hashes in a predefined order within a buffer and applies a second cryptographic hashing operation to compute a composite hash. This composite hash represents the entire signed meter record as a single integrity reference derived from all constituent fragments. The encrypted fragments are subsequently transmitted through a storage interface to distributed storage systems external to the permissioned consortium network. These external storage nodes are optimized for handling large volumes of data and may distribute fragments across multiple locations for redundancy and availability. Despite being stored externally, the fragments remain protected due to encryption, and their integrity can be independently verified using the associated fragment hashes.

Simultaneously, the computed composite hash is stored within the permissioned consortium network in association with the corresponding session or transaction record. This composite hash acts as a compact and immutable reference that enables later verification of the entire segmented record without requiring direct storage of the full data within the network. When verification is required, the encrypted fragments can be retrieved, decrypted if necessary, and reprocessed to recompute individual fragment hashes and the final composite hash. The recomputed composite hash is then compared with the stored value to confirm that the record has remained unchanged across all fragments.

This approach ensures that large meter records can be efficiently managed and stored outside the core network while preserving strong integrity guarantees. The use of per-fragment encryption and hashing, combined with a composite hash anchored within the network, provides a layered verification mechanism that detects tampering at both fragment and aggregate levels.

The computer-implemented method for authenticated electric-vehicle charging and renewable-energy settlement is carried out using physically realized electronic components including processing circuitry, memory elements, metering circuitry, secure cryptographic hardware, and communication interfaces distributed across a consortium control system, a charging station, an electric vehicle, a renewable energy measurement system, and an external storage system. The processor of the consortium control system comprises arithmetic logic circuitry, timing circuitry, and register-based data paths configured to execute cryptographic computations, state updates, and data validation operations through electrical signal manipulation. The electric vehicle includes a hardware-protected credential store formed by secure circuitry that retains a private cryptographic key and performs signing operations within an isolated hardware boundary using dedicated cryptographic execution units. The charging station includes electrical energy measurement circuitry comprising sensing elements, conversion circuits, and measurement registers configured to generate metering data, along with cryptographic hardware configured to produce signed delivery evidence and meter-evidence hashes. The renewable energy measurement system includes sensor-coupled metering hardware and embedded signing circuitry configured to generate authenticated generation evidence. The consortium control system further includes hardware-implemented hashing circuits, signature verification engines, and memory-controlled data structures for maintaining identity, token, settlement, and audit states in physically addressable storage. The external storage system includes encrypted storage devices and memory controllers configured to store signed meter records and to provide hash-linked references through controlled retrieval mechanisms. Data exchange between components is performed through physical communication interfaces and transceivers that convey encoded electrical signals corresponding to nonce values, credential proofs, generation evidence, delivery evidence, and hash references. Each operation of the method, including nonce generation, signature verification, policy evaluation, token computation, escrow locking, delivery validation, and atomic state transition, is executed through coordinated operation of these hardware elements.

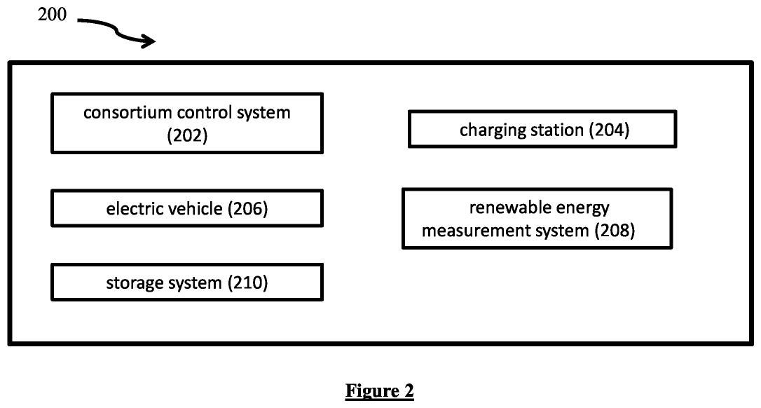

Referring to FIG. 2, a block diagram of a system for authenticated electric-vehicle charging and renewable-energy settlement using a permissioned consortium network is illustrated. The system 200 comprises: a consortium control system (202) including processing circuitry and memory storing instructions and data structures, the consortium control system maintaining an identity registry state, a renewable token state, a settlement state, and an audit state, and being configured to: store credential binding data, revocation indicators, and policy attributes associated with an electric vehicle and a charging station; receive a nonce-bound credential proof associated with a charging session and verify the nonce-bound credential proof using a public key corresponding to the electric vehicle and the stored credential binding data while comparing a cryptographic challenge nonce with a stored session-specific value to detect reuse or mismatch; receive a signed risk digest including a risk score and determine admission of the charging session by comparing the risk score with an authorization threshold and evaluating the policy attributes; generate a session token mapped to a session pseudonym and store a session record in the audit state; receive signed generation evidence including an energy value, an interval identifier, and a meter reference, verify the signed generation evidence using a stored producer credential and an attestation digest, and compute a token quantity from the energy value to update the renewable token state; generate a settlement record based on a requested energy quantity and available token quantities and store escrow entries including a payment amount and the token quantity in the settlement state such that the payment amount and the token quantity remain restricted from transfer; receive signed delivery evidence including a delivered-energy value and a meter-evidence hash, validate correspondence between the meter-evidence hash and a stored hash reference associated with a signed meter record, compare the delivered-energy value with the requested energy quantity using a tolerance condition, and update the settlement state by releasing the payment amount and the token quantity in a single atomic state transition and recording a final receipt in the audit state; a charging station (204) configured to: generate a cryptographic challenge nonce associated with the charging session and transmit the cryptographic challenge nonce to an electric vehicle; receive the nonce-bound credential proof from the electric vehicle and transmit the nonce-bound credential proof to the consortium control system; measure delivered electrical energy during the charging session and generate the signed delivery evidence including the delivered-energy value and the meter-evidence hash derived from a signed meter record; an electric vehicle (206) including a hardware-protected credential store configured to: store a private cryptographic key within protected hardware; receive the cryptographic challenge nonce from the charging station; generate the nonce-bound credential proof by performing a signing operation over the cryptographic challenge nonce, a station identifier, a session pseudonym, and a temporal value; and transmit the nonce-bound credential proof to the charging station; a renewable energy measurement system (208) configured to: acquire renewable-energy generation data from a metering source; generate the signed generation evidence by performing a signing operation over at least the energy value, the interval identifier, and the meter reference; and transmit the signed generation evidence to the consortium control system; a storage system (210) external to the permissioned consortium network configured to: store signed meter records, raw telemetry data, and identifying data in encrypted form; and provide hash references corresponding to the signed meter records; wherein the consortium control system stores only the hash references corresponding to the signed meter records within the permissioned consortium network while maintaining verifiable linkage between the stored hash references and the signed meter records retained in the storage system.

The system is implemented through coordinated operation of processing circuitry, memory units, cryptographic engines, metering devices, and communication interfaces distributed across a consortium control device, charging station apparatus, electric vehicle authentication module, renewable energy measurement device, and external secure storage system. The technique commences upon initiation of a charging request at a charging station, where a session initialization signal is transmitted to the consortium control device. In response, the consortium control device generates a cryptographic challenge nonce using a composite construction sequence that combines a station identifier, a session pseudonym generated through a pseudonymization engine, a monotonic counter retrieved from a session register, and a timestamp derived from a system clock module. These values are concatenated and processed through a cryptographic hash function executed within a dedicated hashing circuit to produce a fixed-length nonce value, which is stored in a session record along with a freshness indicator and counter state.

The generated nonce is transmitted via a secure communication interface to the charging station and subsequently relayed to the electric vehicle. Within the electric vehicle, an authentication module comprising a hardware-protected credential store retrieves a private cryptographic key retained in a secure execution region. A signing engine within the module constructs a nonce-bound credential proof by combining the received nonce, the station identifier, the session pseudonym, and a temporal value obtained from a synchronized vehicle clock. These elements are processed through a digital signature technique implemented in cryptographic circuitry, producing a signed proof that is transmitted back through the charging station to the consortium control device.

Upon receipt of the nonce-bound credential proof, the consortium control device invokes a verification sequence in which a parsing engine extracts the embedded parameters, including the nonce, temporal value, and credential identifier. A credential retrieval unit accesses an identity registry state stored in memory to obtain corresponding credential binding data, including a public key reference, issuer signature, issuance timestamp, and revocation flag. A hierarchical validation operation is then executed in which the issuer signature is verified using a stored issuer public key, the issuance timestamp is compared against a predefined validity interval, and the revocation flag is examined to confirm that the credential remains valid. Following successful credential validation, a signature verification engine computes a verification operation using the retrieved public key and compares the resulting value with the received signature to confirm authenticity of the nonce-bound credential proof.

Simultaneously, the technique performs nonce validation by comparing the received nonce with the stored session-specific nonce value maintained in the session record. A reconstruction module recomputes the nonce by concatenating the original inputs and applying the same cryptographic hash function, ensuring that the recomputed nonce matches the stored value. A bounded nonce-cache structure indexed by station identifier and session pseudonym is accessed to detect reuse of previously accepted nonce values, with eviction of stale entries governed by a least-recently-used sequence. Temporal validation is also performed by computing a difference between the received temporal value and the current system time, and comparing the difference against a predefined threshold to ensure that the credential proof falls within an acceptable time window. Any mismatch, reuse, or temporal deviation results in immediate rejection of the authentication attempt.

Following successful authentication, a policy evaluation engine retrieves policy data structures indexed by the electric vehicle identifier and charging station identifier. The technique executes a rule evaluation sequence in which parameters such as requested energy quantity, geographic attributes derived from the station identifier, and credential trust level are compared against constraint fields stored in the policy data structure. Concurrently, a signed risk digest is received from an external risk analytics module and verified using a stored verification key. A risk score extracted from the digest is compared against an authorization threshold maintained in the identity registry state. Admission of the charging session is granted only when both policy evaluation and risk assessment satisfy predefined conditions.

Upon admission, a session token generation module constructs a structured token object containing the session pseudonym, a unique token identifier, a validity interval, and a station-binding value. A token hash is computed by applying a cryptographic hash function to the structured object, and the hash is signed using a private key associated with the consortium control device to produce a signed token value. The session token and corresponding hash reference are stored in the audit state, and the session record is updated to reflect an admitted state.

In parallel, the technique processes renewable energy generation through a renewable energy measurement device that acquires generation data from a metering source. A firmware integrity module retrieves a measurement value representing the execution state of the device firmware, which is compared against a trusted measurement stored in the identity registry state. Only when the firmware measurement matches the trusted value does the technique proceed to generate signed generation evidence. A signing processor within the measurement device produces a signature over the energy value, interval identifier, and meter reference, and transmits the signed evidence to the consortium control device.

Upon receipt, the consortium control device verifies the producer credential associated with the measurement device and validates the attestation digest. A tokenization engine converts the verified energy value into a normalized unit using a scaling factor, and applies a tokenization factor using fixed-point arithmetic implemented in arithmetic circuitry. An intermediate token value is generated and processed through a deterministic rounding module to produce a final token quantity, which is stored in the renewable token state.

The technique then performs a matching operation to allocate token quantities to the charging session. A token selection processor constructs an ordered list of available token quantities and computes a composite ordering value for each entry using weighted parameters including price, timestamp, and source identifier. The list is normalized and sorted using a deterministic sorting sequence implemented in hardware logic. Token quantities are sequentially selected until the requested energy quantity is satisfied, and a settlement record is generated containing identifiers of selected tokens and associated pricing data.

Subsequently, an escrow management module creates escrow entries comprising a payment lock identifier and a token lock identifier. These entries are associated with the settlement record and stored in the settlement state with a lock state indicator that prevents modification or release during the charging session. As the charging session progresses, the charging station device generates intermediate metering values that are aggregated by an accumulation engine to compute a cumulative energy value.

Upon completion of the charging session, the charging station generates signed delivery evidence including a delivered-energy value and a meter-evidence hash derived from a signed meter record. The consortium control device computes a hash over the received signed meter record and compares it with a stored hash reference retrieved from the permissioned consortium network. A comparison engine calculates a deviation value between the delivered-energy value and the requested energy quantity and compares it with a tolerance threshold stored in the settlement state. If the deviation exceeds the threshold or hash validation fails, the escrow entries remain locked and a deviation indicator is recorded in the audit state.

When validation conditions are satisfied, an atomic transaction engine executes a state transition by generating a transaction input sequence including payment amount, token quantity, delivered-energy value, and meter-evidence hash. A transaction digest is computed using a cryptographic hash function and submitted to a consensus validation process within the consortium network. Upon successful validation, the settlement state and audit state are updated in a single write operation, releasing both payment and token quantities simultaneously and preventing partial updates.

In an embodiment, a consortium control device is provided, comprising high-performance processing circuitry, non-volatile memory modules, cryptographic processing units, and communication interfaces configured to operate within a permissioned consortium network. The consortium control device maintains structured data repositories including an identity registry state, a renewable token state, a settlement state, and an audit state, each stored within memory arrays coupled to the processing circuitry. The device is configured to generate a cryptographic challenge nonce using a hardware-based random number generator combined with deterministic inputs including a station identifier, session pseudonym, monotonic counter, and system clock timestamp. The generated nonce is stored in a session register along with a freshness indicator to prevent replay attacks.

Upon receiving a charging request, the consortium control device transmits the cryptographic challenge nonce and station authentication data via a secure communication interface to a charging station device. The charging station device, comprising a metering unit, embedded controller, communication transceiver, and cryptographic module, forwards the nonce to an electric vehicle. The electric vehicle is equipped with an onboard authentication module including a hardware-protected credential store implemented using a secure element or trusted execution module. The authentication module generates a nonce-bound credential proof by performing a cryptographic signing operation using a private key retained within the protected hardware. The proof incorporates the received nonce, station identifier, session pseudonym, and a temporal value derived from a vehicle clock module.

The charging station device receives the nonce-bound credential proof and transmits it to the consortium control device. The consortium control device extracts credential identifiers from the proof and retrieves corresponding credential binding data from the identity registry state. Using a public key associated with the electric vehicle, the device performs signature verification within a cryptographic verification engine. Simultaneously, the device compares the received nonce with the stored session nonce and validates temporal constraints using a bounded time-window verification circuit. A nonce-cache structure implemented in memory ensures that previously used nonces are not reused, thereby preventing replay or duplication attacks.

The consortium control device further evaluates policy attributes using a hardware-accelerated rule evaluation engine. Policy data structures indexed by station and vehicle identifiers are processed to determine compliance with constraints such as geographic restrictions, energy limits, and credential trust levels. Additionally, the device receives a signed risk digest from an external risk analytics module and verifies the digest signature using stored verification keys. A comparator circuit evaluates the risk score against a predefined authorization threshold to determine admission of the charging session.

Upon successful validation, the consortium control device generates a session token using a token construction engine. The session token is structured as a signed data object including session pseudonym, token identifier, validity interval, and binding parameters. The token is cryptographically signed using a private key associated with the consortium control device and stored in the audit state along with a corresponding hash reference.

In parallel, a renewable energy measurement device is provided, comprising a calibrated metering unit, firmware integrity module, and cryptographic signing processor. The device measures renewable energy generation and produces signed generation evidence including an energy value, interval identifier, and meter reference. The consortium control device verifies the signed generation evidence by validating the producer credential and comparing firmware measurement values against trusted measurements stored in the identity registry state. Upon successful validation, a tokenization engine converts the measured energy into token quantities using fixed-point arithmetic and deterministic rounding logic, updating the renewable token state.

The consortium control device performs a matching operation using a token selection processor that constructs an ordered list of available token quantities. A composite scoring mechanism evaluates price, timestamp, and policy-derived weights to determine optimal token selection. Selected tokens are associated with a settlement record, and escrow entries are created using a lock management module. The escrow entries include a payment lock identifier and token lock identifier stored in the settlement state, preventing premature transfer.

During the charging session, the charging station device continuously measures delivered electrical energy using its metering unit and generates intermediate metering values. Upon completion, a signed delivery evidence record is generated, including delivered energy value and a meter-evidence hash derived from a signed meter record. The consortium control device validates the meter-evidence hash by recomputing hash values and comparing them with stored references maintained within the permissioned consortium network.

A comparison engine computes deviation between delivered energy and requested energy quantities using tolerance thresholds stored in the settlement state. If validation conditions are satisfied, the consortium control device executes an atomic state transition using a transaction processing engine. The transition releases both payment and token quantities simultaneously, ensuring that no partial state updates occur. A final receipt including a hash reference to the signed meter record is stored in the audit state.

The system further comprises a distributed storage device external to the consortium network, including encrypted storage arrays and hash generation modules. Signed meter records, raw telemetry data, and identifying data are encrypted using encryption keys managed by the consortium control device and stored externally. Corresponding hash references are stored within the consortium network, thereby maintaining verifiable linkage without exposing sensitive data.

In another embodiment, the system incorporates a segmentation engine that divides signed meter records into multiple encrypted fragments. Each fragment is hashed individually, and a composite hash is generated to represent the complete record. This composite hash is stored within the consortium network, enabling efficient verification of data integrity.

The system is implemented using physically instantiated electronic components that cooperatively perform electrical signal processing, cryptographic transformation, data storage, and controlled state updating operations. The consortium control system includes processing circuitry coupled with memory elements and dedicated cryptographic engines configured to generate session-specific nonce values using clock-driven counters, perform signature verification through arithmetic operations executed in cryptographic hardware, and execute hash generation using hardware-accelerated hashing circuits. The identity registry state, renewable token state, settlement state, and audit state are maintained within memory arrays and persistent storage devices that store structured data in addressable locations accessible through bus-controlled read and write operations. The charging station includes electrical metering circuitry configured to measure delivered energy using current and voltage sensing elements and to generate metering outputs that are converted into digitally signed records using embedded cryptographic hardware. The electric vehicle includes a hardware-protected credential store comprising secure circuitry such as a secure element or trusted execution hardware that retains a private cryptographic key and performs signing operations internally without exposing the key material outside the protected boundary. The renewable energy measurement system includes metering hardware configured to acquire generation data from sensors and to generate digitally signed generation evidence using embedded signing circuitry. The external storage system includes encrypted storage devices and memory controllers configured to store signed meter records and telemetry data in encrypted form and to return corresponding hash-linked references upon request. Communication between the components is carried out through physical communication interfaces that transmit encoded data signals representing nonce values, credential proofs, generation evidence, delivery evidence, and hash references.

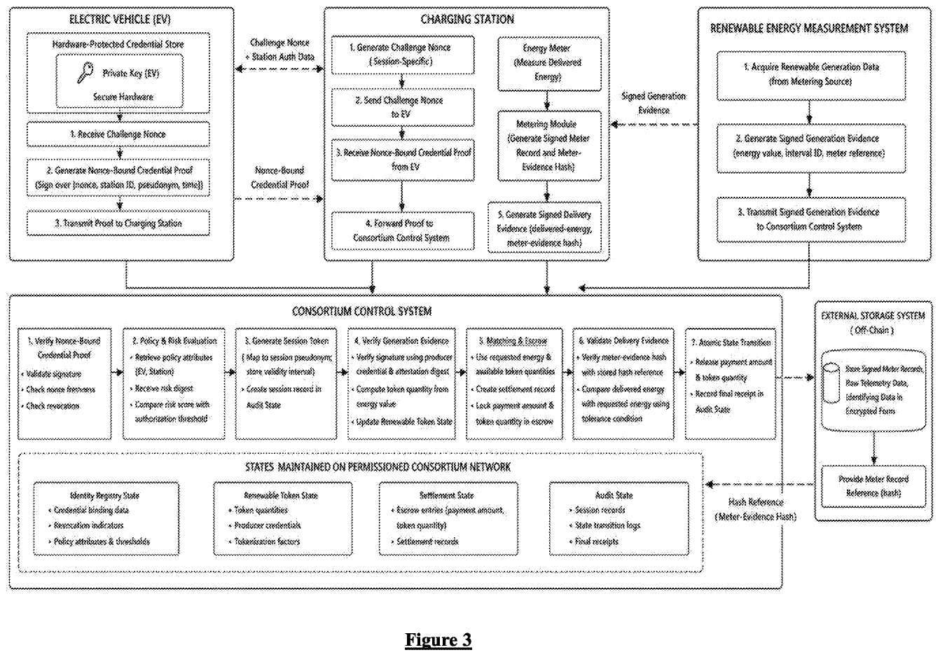

FIG. 3 illustrates a system for authenticated electric-vehicle charging and renewable-energy settlement using a permissioned consortium network, wherein multiple physically distinct components interact through defined data exchanges and cryptographic operations to enable secure admission of charging sessions, verifiable energy tokenization, escrow-controlled settlement, and audit-compliant record maintenance.

An electric vehicle includes a hardware-protected credential store implemented using secure circuitry configured to retain a private cryptographic key within a protected hardware environment. The secure circuitry is configured to receive a cryptographic challenge nonce transmitted from a charging station and to generate a nonce-bound credential proof by performing a signing operation over a data structure including the cryptographic challenge nonce, a station identifier, a session pseudonym, and a temporal value. The electric vehicle transmits the nonce-bound credential proof to the charging station, while preventing exposure of the private cryptographic key outside the protected hardware.

A charging station is configured to initiate a charging session by generating a session-specific cryptographic challenge nonce and transmitting the cryptographic challenge nonce along with station authentication data to the electric vehicle. The charging station receives the nonce-bound credential proof from the electric vehicle and forwards the nonce-bound credential proof to a consortium control system. During the charging session, the charging station measures delivered electrical energy using a metering mechanism and generates signed delivery evidence including a delivered-energy value and a meter-evidence hash derived from a signed meter record. The charging station transmits the signed delivery evidence to the consortium control system for validation.

A renewable energy measurement system is configured to acquire renewable-energy generation data from a metering source and to generate signed generation evidence by performing a signing operation over at least an energy value, an interval identifier, and a meter reference. The renewable energy measurement system transmits the signed generation evidence to the consortium control system, enabling subsequent tokenization of renewable energy. A consortium control system includes processing circuitry and memory storing instructions and data structures and is configured to maintain an identity registry state, a renewable token state, a settlement state, and an audit state within the permissioned consortium network. The consortium control system receives the nonce-bound credential proof and verifies a signature using a public key associated with the electric vehicle, retrieves credential binding data and revocation indicators from the identity registry state, and validates a freshness condition of the cryptographic challenge nonce to prevent replay. The consortium control system evaluates policy attributes associated with the electric vehicle and the charging station and processes a signed risk digest received from a risk analytics service, the signed risk digest including a risk score and a digest signature. The risk score is compared with an authorization threshold stored in the identity registry state to determine admission of the charging session.

Upon successful verification and evaluation, the consortium control system generates a session token mapped to the session pseudonym, assigns a validity interval to the session token, and stores a session record in the audit state. The consortium control system receives signed generation evidence and verifies the signed generation evidence using a stored producer credential and an attestation digest, and computes a token quantity from the energy value using a tokenization factor to update the renewable token state.

The consortium control system performs a matching operation by comparing a requested energy quantity associated with the charging session with available token quantities and generates a settlement record. A payment amount and the token quantity are locked in escrow entries within the settlement state such that the payment amount and the token quantity remain restricted from transfer until validation of delivery evidence is completed.

The consortium control system receives signed delivery evidence from the charging station and validates correspondence between the meter-evidence hash and a stored hash reference corresponding to a signed meter record. The delivered-energy value is compared with the requested energy quantity using a tolerance condition. When the validation fails, the consortium control system maintains the escrow entries in a locked state and records a dispute entry in the audit state. When the validation succeeds, the consortium control system executes a single atomic state transition releasing the payment amount and the token quantity, generates a final receipt, and updates the audit state with the finalized settlement record.

An external storage system is configured to store signed meter records, raw telemetry data, and identifying data in encrypted form and to provide meter record references corresponding to meter-evidence hashes. The consortium control system stores only hash references corresponding to the signed meter records within the permissioned consortium network, thereby maintaining verifiable linkage between data stored in the external storage system and records maintained within the consortium network without exposing underlying sensitive information.

The permissioned consortium network maintains the identity registry state including credential binding data, revocation indicators, and policy attributes, the renewable token state including token quantities and producer credentials, the settlement state including escrow entries and settlement records, and the audit state including session records, state transition logs, and final receipts. Data flows between the electric vehicle, the charging station, the renewable energy measurement system, the consortium control system, and the external storage system include exchange of cryptographic challenge nonce and credential proof, transmission of signed generation evidence and signed delivery evidence, lookup of meter record references using meter-evidence hashes, and internal state updates performed by the consortium control system to complete authenticated charging and renewable-energy settlement.

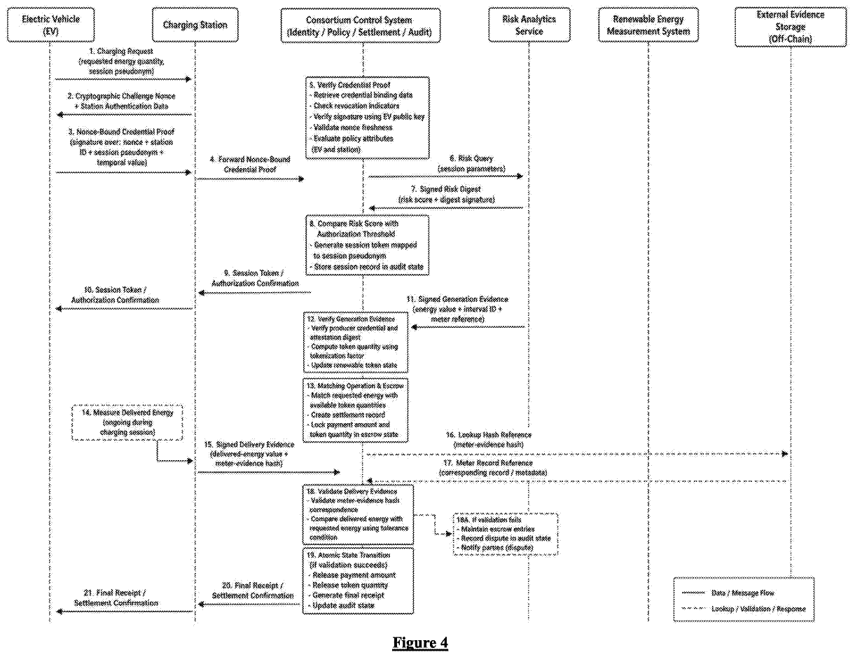

FIG. 4 illustrates a sequence of operations for authenticated electric-vehicle charging and renewable-energy settlement, depicting interactions among an electric vehicle, a charging station, a consortium control system, a risk analytics service, a renewable energy measurement system, and an external evidence storage system. The sequence represents a time-ordered exchange of data and validation steps that collectively enable secure session authorization, energy matching, escrow management, and final settlement.

An electric vehicle initiates a charging session by transmitting a charging request to the charging station, the charging request including at least a requested energy quantity and a session pseudonym. In response, the charging station generates a cryptographic challenge nonce associated with the charging session and transmits the cryptographic challenge nonce along with station authentication data to the electric vehicle. The electric vehicle receives the cryptographic challenge nonce and generates a nonce-bound credential proof by performing a signing operation over a data structure including the cryptographic challenge nonce, a station identifier, the session pseudonym, and a temporal value. The nonce-bound credential proof is transmitted from the electric vehicle to the charging station, which forwards the nonce-bound credential proof to the consortium control system.

Upon receipt of the nonce-bound credential proof, the consortium control system performs credential verification by retrieving credential binding data and revocation indicators from an identity registry state, verifying the signature using a public key associated with the electric vehicle, and validating freshness of the cryptographic challenge nonce to prevent replay. The consortium control system further evaluates policy attributes associated with the electric vehicle and the charging station and generates a risk query including session parameters, which is transmitted to the risk analytics service. The risk analytics service processes the risk query and returns a signed risk digest including a risk score and a digest signature. The consortium control system verifies the signed risk digest and compares the risk score with an authorization threshold to determine whether to admit the charging session.

Following successful evaluation, the consortium control system generates a session token mapped to the session pseudonym and stores a corresponding session record in an audit state. The session token or an authorization confirmation is transmitted to the charging station and further conveyed to the electric vehicle, thereby enabling continuation of the charging session.

The consortium control system receives signed generation evidence from the renewable energy measurement system, the signed generation evidence including an energy value, an interval identifier, and a meter reference. The consortium control system verifies the signed generation evidence using a stored producer credential and an attestation digest and computes a token quantity from the energy value using a tokenization factor, updating a renewable token state accordingly.

The consortium control system performs a matching operation by comparing the requested energy quantity associated with the charging session with available token quantities, generating a settlement record, and locking a payment amount and the token quantity in escrow entries within a settlement state such that the payment amount and the token quantity remain restricted during the charging session.

During the charging session, the charging station measures delivered electrical energy and generates signed delivery evidence including a delivered-energy value and a meter-evidence hash derived from a signed meter record. The signed delivery evidence is transmitted to the consortium control system. In response, the consortium control system initiates a lookup operation by transmitting a request including the meter-evidence hash to the external evidence storage system, which returns a corresponding meter record reference or metadata associated with the signed meter record. The consortium control system validates the delivery evidence by verifying correspondence between the meter-evidence hash and the retrieved meter record reference and by comparing the delivered-energy value with the requested energy quantity using a tolerance condition. When validation fails, the consortium control system maintains the escrow entries in a locked state, records a dispute entry in the audit state, and triggers notification actions. When validation succeeds, the consortium control system executes a single atomic state transition that releases the payment amount and the token quantity, generates a final receipt, and updates the audit state to reflect completion of the settlement. The final receipt or settlement confirmation is transmitted from the consortium control system to the charging station and subsequently to the electric vehicle, thereby completing the charging and settlement process. The sequence further illustrates that cryptographic operations, validation checks, and state updates are performed in coordination across the participating components, and that external storage is utilized for maintaining signed meter records while the consortium control system retains corresponding hash references for verification within the permissioned consortium network.

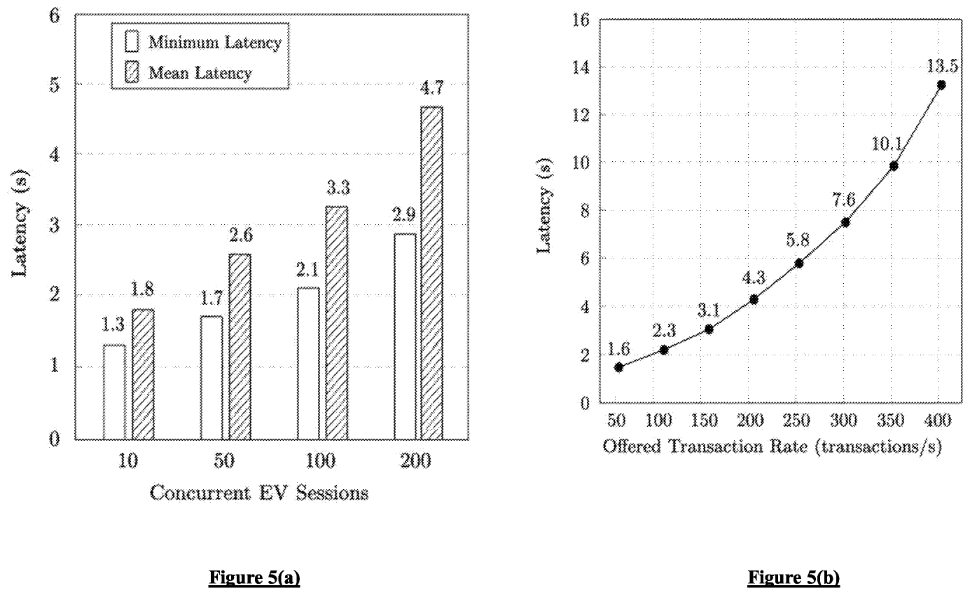

FIG. 5(a) illustrates authentication latency associated with admission of electric-vehicle charging sessions under increasing concurrency levels, where the horizontal axis represents concurrent electric-vehicle sessions and the vertical axis represents latency in seconds. The figure presents both minimum latency and mean latency corresponding to authentication operations performed at the consortium control system. At a lower concurrency level of 10 sessions, the minimum latency is approximately 1.3 seconds and the mean latency is approximately 1.8 seconds, indicating that credential verification, nonce validation, policy evaluation, and risk assessment operations are completed within a short and consistent time interval. As concurrency increases to 50 sessions, the minimum latency increases to approximately 1.7 seconds and the mean latency increases to approximately 2.6 seconds, reflecting additional processing overhead due to simultaneous handling of multiple nonce-bound credential proofs and associated validation steps. At 100 concurrent sessions, the minimum latency further increases to approximately 2.1 seconds and the mean latency increases to approximately 3.3 seconds, indicating increased queuing and scheduling overhead in cryptographic verification and policy evaluation processes. At a higher concurrency level of 200 sessions, the minimum latency reaches approximately 2.9 seconds and the mean latency reaches approximately 4.7 seconds. The gradual and proportional increase in both minimum and mean latency demonstrates that authentication operations scale predictably with concurrent session load, while maintaining bounded performance. The difference between minimum and mean latency at each concurrency level reflects variability introduced by concurrent execution of cryptographic verification, retrieval of credential binding data and revocation indicators, and processing of signed risk digests.

FIG. 5(b) illustrates settlement latency as a function of an offered transaction rate, where the horizontal axis represents the offered transaction rate in transactions per second and the vertical axis represents latency in seconds. The settlement latency corresponds to a time interval from receipt of valid signed delivery evidence to completion of an atomic state transition, including validation of meter-evidence hash correspondence, comparison of delivered energy with requested energy, release of escrowed payment and token quantities, and recording of a final receipt. At a transaction rate of 50 transactions per second, the settlement latency is approximately 1.6 seconds, indicating efficient processing of delivery evidence validation and state update operations. As the transaction rate increases to 100 transactions per second, the latency increases to approximately 2.3 seconds, reflecting additional processing load associated with concurrent validation operations. At 150 transactions per second, the latency increases to approximately 3.1 seconds, and at 200 transactions per second, the latency increases to approximately 4.3 seconds, indicating progressive computational and coordination overhead. At higher transaction rates of 250 and 300 transactions per second, the latency increases to approximately 5.8 seconds and 7.6 seconds, respectively, showing a continued upward trend as more settlement operations are processed concurrently. At 350 transactions per second, the latency reaches approximately 10.1 seconds, and at 400 transactions per second, the latency increases to approximately 13.5 seconds. The monotonic increase in settlement latency reflects increased workload associated with verification of meter-evidence hashes, retrieval of corresponding meter records from external storage, execution of matching operations, and coordination of atomic state transitions within the permissioned consortium network. The plotted values demonstrate that settlement latency scales in a predictable manner with transaction throughput while maintaining correctness of escrow handling and final settlement operations.

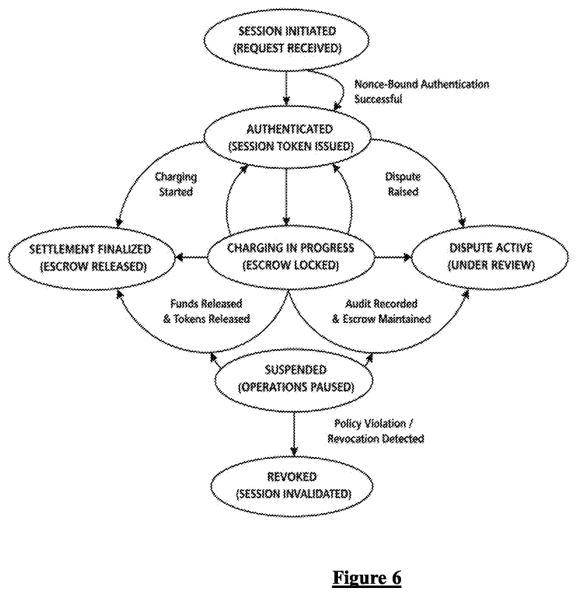

FIG. 6 illustrates a state transition representation of a charging session lifecycle executed within the authenticated electric-vehicle charging and renewable-energy settlement system, wherein the progression of a session is governed by validation outcomes, escrow conditions, and policy enforcement. The sequence begins at a state corresponding to session initiation, in which a charging request is received from an electric vehicle. Upon receipt of the request, a nonce-bound authentication procedure is performed, and when authentication is successful, the system transitions to an authenticated state in which a session token is issued. The authenticated state represents successful verification of a nonce-bound credential proof, validation of credential binding data and revocation indicators, and satisfaction of policy and risk evaluation conditions.

From the authenticated state, the session transitions to a charging-in-progress state upon commencement of charging operations. In the charging-in-progress state, a payment amount and a corresponding renewable token quantity are placed into escrow, resulting in an escrow-locked condition. The escrow-locked condition indicates that settlement resources are reserved and restricted from transfer until completion of delivery validation.

During the charging-in-progress state, the system supports multiple transition paths depending on operational outcomes. When charging proceeds without anomaly and delivery evidence is validated successfully, the system transitions toward a settlement-finalized state. In this transition, funds and token quantities held in escrow are released, and a final receipt is generated and recorded in an audit state, thereby completing the settlement process.

Alternatively, when a dispute condition is triggered during charging, the system transitions from the charging-in-progress state to a dispute-active state. The dispute-active state represents a condition in which delivery evidence validation has failed or inconsistencies have been detected, and corresponding audit records are generated while maintaining escrow entries in a locked state. The dispute-active state enables further review and resolution processes without releasing escrowed resources.

The system further includes a suspended state representing a temporary halt of operations. Transition to the suspended state occurs in response to intermediate conditions such as incomplete validation, temporary system constraints, or administrative actions. While in the suspended state, escrow entries remain maintained, and audit records continue to be preserved. From the suspended state, the system may transition back toward settlement completion or dispute handling depending on subsequent validation outcomes. A revocation state is provided to represent invalidation of the session due to detection of policy violations, credential revocation, or other disqualifying conditions. Transition to the revocation state occurs from the suspended state when a policy violation or revocation condition is detected. In the revocation state, the session is invalidated, preventing further progression toward settlement and maintaining system integrity.

The transitions illustrated in the figure demonstrate that session progression is governed by a combination of authentication results, escrow management, delivery evidence validation, audit recording, and policy enforcement. The inclusion of escrow-locked, dispute-active, suspended, and revocation states ensures that the system maintains consistency and security across all operational scenarios while enabling controlled release of payment and token quantities only upon successful validation.

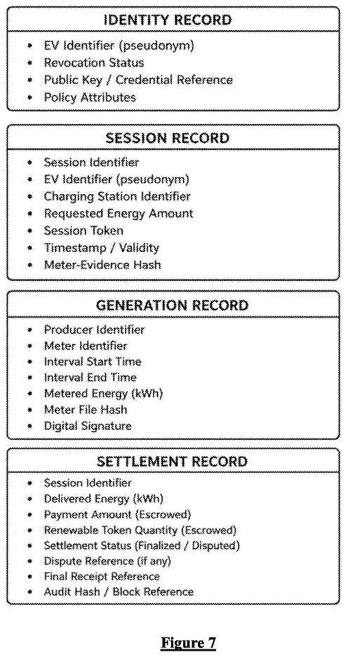

FIG. 7 illustrates representative data structures maintained within the permissioned consortium network for enabling authenticated electric-vehicle charging and renewable-energy settlement, wherein distinct records are structured to support identity management, session tracking, renewable energy tokenization, and escrow-based settlement with auditability.

An identity record is maintained to represent credential and policy-related attributes associated with an electric vehicle. The identity record includes an electric-vehicle identifier represented as a pseudonym, which enables identification without exposing underlying identity information. The identity record further includes a revocation status indicating whether a corresponding credential is valid or has been revoked. A public key or credential reference is stored to enable verification of signatures generated by the electric vehicle during nonce-bound authentication. Policy attributes are also included within the identity record to define constraints and authorization parameters applicable to charging sessions, including conditions evaluated during admission and risk assessment.

A session record is maintained to represent parameters and state information associated with an individual charging session. The session record includes a session identifier uniquely identifying the session, and an electric-vehicle identifier corresponding to the pseudonym used during authentication. A charging station identifier is included to associate the session with a specific charging infrastructure. The session record further includes a requested energy amount indicating a target quantity of energy requested by the electric vehicle, and a session token issued upon successful authentication and policy evaluation. Timestamp and validity information are stored to define a temporal scope of the session token. The session record also includes a meter-evidence hash corresponding to delivery evidence generated during the charging session, enabling linkage between measured energy delivery and subsequent validation operations.

A generation record is maintained to represent renewable energy generation data used for tokenization. The generation record includes a producer identifier corresponding to a renewable energy source and a meter identifier associated with a metering device. The record further includes an interval start time and an interval end time defining a time window for energy generation. A metered energy value expressed in kilowatt-hours is stored to quantify generated energy. A meter file hash is included to provide a cryptographic reference to detailed metering data stored externally. A digital signature is included to ensure authenticity and integrity of the generation record, enabling verification using a producer credential.

A settlement record is maintained to represent escrow-controlled settlement information associated with a charging session. The settlement record includes a session identifier linking the settlement record to a corresponding session record. A delivered energy value expressed in kilowatt-hours is included to represent actual energy delivered during the charging session. A payment amount is stored in escrow, representing monetary value reserved for settlement, and a renewable token quantity is stored in escrow, representing tokenized renewable energy allocated for the session. A settlement status indicates whether the settlement has been finalized or is subject to dispute. A dispute reference is included when a dispute condition arises, enabling tracking of dispute resolution processes. A final receipt reference is stored upon successful completion of settlement, providing a verifiable record of transaction completion. An audit hash or block reference is included to link the settlement record to an audit trail maintained within the permissioned consortium network, ensuring traceability and integrity of recorded transactions.

The records illustrated collectively enable coordinated operation of authentication, energy tokenization, escrow management, and settlement validation processes, while preserving data integrity, traceability, and controlled disclosure within the system.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A computer-implemented method for authenticated electric-vehicle charging and renewable-energy settlement executed by a processor of a consortium control system associated with a permissioned consortium network, the method comprising:
transmitting a cryptographic challenge nonce and station authentication data to an electric vehicle responsive to a charging request received from a charging station, the cryptographic challenge nonce being generated as a session-specific value and stored with a freshness indicator in a session record;
receiving a nonce-bound credential proof generated using a private key retained within a hardware-protected credential store of the electric vehicle, the nonce-bound credential proof including a signature computed over at least the cryptographic challenge nonce, a station identifier, a session pseudonym, and a temporal value;
extracting an identifier from the nonce-bound credential proof and retrieving corresponding credential binding data and revocation indicators from an identity registry state, and verifying the signature of the nonce-bound credential proof using a public key associated with the electric vehicle while simultaneously comparing the cryptographic challenge nonce with a stored session-specific value and rejecting the nonce-bound credential proof when the cryptographic challenge nonce does not match the stored session-specific value or corresponds to a previously processed session;
evaluating policy attributes associated with the electric vehicle and the charging station, receiving a signed risk digest including a risk score and a digest signature from a risk-analytics service, and comparing the risk score with an authorization threshold stored in the identity registry state to determine admission of a charging session;
generating a session token mapped to the session pseudonym only after successful signature verification, revocation evaluation, nonce validation, and policy evaluation, and storing the session token with a validity interval such that the session token is rendered invalid upon completion of settlement or expiration of the validity interval;
receiving signed generation evidence representing renewable-energy generation, the signed generation evidence including at least an energy value, an interval identifier, and a meter reference, and verifying the signed generation evidence by validating a producer credential and an attestation digest prior to further processing;
computing a token quantity from the energy value using a tokenization factor and updating a renewable token state only when the signed generation evidence satisfies credential validation and attestation conditions;
executing a matching operation using a requested energy quantity associated with the charging request and available token quantities to generate a settlement record, and creating escrow entries in a settlement state by locking a payment amount and the token quantity such that the payment amount and the token quantity remain inaccessible for transfer during the charging session;
receiving signed delivery evidence corresponding to electrical energy delivered to the electric vehicle, the signed delivery evidence including a delivered-energy value and a meter-evidence hash derived from a signed meter record, and validating correspondence between the meter-evidence hash and the signed meter record by comparing the meter-evidence hash with a stored hash reference linked to the signed meter record;
comparing the delivered-energy value with the requested energy quantity using a tolerance condition and maintaining the escrow entries in a locked state when the delivered-energy value falls outside the tolerance condition or when the meter-evidence hash fails validation;
executing a single atomic state transition releasing the payment amount and the token quantity only after validation of the meter-evidence hash and satisfaction of the tolerance condition, and recording a final receipt in an audit state including a hash reference to the signed meter record; and
storing signed meter records, raw telemetry data, and identifying data in encrypted storage external to the permissioned consortium network while storing corresponding hash references within the permissioned consortium network to maintain verifiable linkage between stored data and processed settlement records, wherein generating the cryptographic challenge nonce comprises computing the cryptographic challenge nonce using a composite nonce-construction sequence including concatenating a station identifier, a session pseudonym, a monotonically increasing counter stored in the session record, and a timestamp derived from a system clock of the consortium control system, applying a cryptographic hash function to a concatenated sequence to obtain a fixed-length nonce value, storing the fixed-length nonce value and the monotonically increasing counter in the session record, and subsequently validating the nonce-bound credential proof by reconstructing the concatenated sequence and recomputing the cryptographic hash function to verify correspondence with the fixed-length nonce value, such that replayed or reordered nonce-bound credential proofs are detected through mismatch in reconstructed sequence, wherein generating the cryptographic challenge nonce comprises constructing a nonce input sequence including a station identifier, the session pseudonym, a monotonic counter stored in the session record, and a timestamp value, applying a keyed cryptographic hash function to the nonce input sequence using a secret key stored within the consortium control system to produce the cryptographic challenge nonce, storing the monotonic counter and the timestamp value in the session record, and validating the nonce-bound credential proof by reconstructing the nonce input sequence and recomputing the keyed cryptographic hash function to detect deviation between a reconstructed cryptographic challenge nonce and transmitted cryptographic challenge nonce; wherein verifying the nonce-bound credential proof further comprises performing a dual-binding validation including verifying that the signature is computed over both the cryptographic challenge nonce and the station identifier and verifying that the station identifier included in the nonce-bound credential proof corresponds to a station identifier stored in the session record, and rejecting the nonce-bound credential proof when either binding condition is not satisfied; and wherein generating the session token further comprises constructing a session-control record stored in the audit state, the session-control record including a state-transition constraint table defining permissible transitions between session states, encoding the state-transition constraint table as a structured data sequence including permitted source states and permitted destination states, validating each requested state transition by retrieving the session-control record and comparing a requested transition against the state-transition constraint table, and preventing progression of the session record to a subsequent state when the requested transition is not represented within the state-transition constraint table, and wherein executing the matching operation further comprises constructing, within the settlement state, an ordered token-selection structure including a plurality of candidate token entries, computing for each candidate token entry a composite ordering value derived from a weighted combination of a price parameter, a timestamp parameter, and a source identifier, normalizing the composite ordering value using a scaling sequence to ensure comparable magnitude across candidate token entries, sorting the candidate token entries based on a normalized composite ordering value using a deterministic sorting sequence, and selecting token quantities sequentially from a sorted candidate token entries until the requested energy quantity is satisfied.

2. The method of claim 1, wherein normalizing the composite ordering value using the scaling sequence comprises converting the composite ordering value associated with each candidate token entry into a normalized composite ordering value by applying a scaling factor corresponding to at least one of a price parameter range, a time parameter range, or a policy-derived weighting factor range such that comparable magnitude is ensured across candidate token entries, and wherein sorting candidate token entries based on the normalized composite ordering value using the deterministic sorting sequence comprises performing successive comparison operations between normalized composite ordering values associated with the candidate token entries, arranging the candidate token entries according to comparison results generated from the successive comparison operations, resolving equivalent normalized composite ordering values using at least one secondary parameter including a timestamp value or a token identifier such that identical input candidate token entries produce an identical sorted candidate token entry sequence, and selecting token quantities sequentially from the sorted candidate token entries until the requested energy quantity is satisfied.

3. The method of claim 1, wherein verifying the nonce-bound credential proof comprises parsing the nonce-bound credential proof to extract the temporal value and performing a bounded time-window validation by computing a difference between the temporal value and a current system time maintained by the consortium control system, comparing the difference against a stored temporal threshold, and rejecting the nonce-bound credential proof when the temporal value falls outside bounded time-window, while additionally maintaining a nonce usage record indexed by the session pseudonym to detect reuse of previously accepted nonce-bound credential proofs; and wherein retrieving the credential binding data further comprises accessing a credential record structured as a multi-field data object including a public key reference, an issuer signature, a credential issuance timestamp, and a revocation flag, and performing a hierarchical validation sequence including verifying the issuer signature using an issuer public key stored in the identity registry state, validating the credential issuance timestamp against a validity interval, and confirming absence of the revocation flag prior to performing signature verification of the nonce-bound credential proof.

4. The method of claim 1, wherein evaluating the policy attributes comprises retrieving a policy data structure indexed by the station identifier and an electric vehicle identifier, the policy data structure including a plurality of constraint fields, and computing a policy decision by executing a rule-evaluation sequence that compares the requested energy quantity, a geographic attribute derived from the station identifier, and a credential trust level against corresponding constraint fields, and generating a policy evaluation result stored in the session record for subsequent audit-state inclusion; and wherein receiving the signed risk digest comprises verifying the digest signature using a verification key associated with the risk-analytics service, extracting a model-version identifier and a digest reference from the signed risk digest, computing a hash over the model-version identifier and the digest reference, and storing the hash in the audit state in association with the session record to provide traceability of a risk evaluation applied during admission.

5. The method of claim 1, wherein generating the session token comprises constructing the session token as a structured data object including the session pseudonym, a token identifier, a validity interval, and a station-binding value, applying a cryptographic signing operation over the structured data object using a private key associated with the consortium control system, storing a hash of the structured data object in the audit state, and subsequently validating the session token during processing by recomputing the hash and comparing it with the stored hash reference to detect tampering; and wherein receiving the signed generation evidence further comprises extracting the meter reference and retrieving a corresponding attestation digest including a firmware measurement value, comparing the firmware measurement value with a trusted measurement value stored in the identity registry state, and permitting computation of the token quantity only when the firmware measurement value matches the trusted measurement value, such that generation evidence originating from altered execution environments is excluded from tokenization.

6. The method of claim 1, wherein computing the token quantity comprises converting the energy value into a normalized unit using a scaling factor, applying the tokenization factor using fixed-point arithmetic with a predetermined precision level, generating an intermediate token value, and applying a deterministic rounding rule defined in the renewable token state to obtain the token quantity stored in the renewable token state; and wherein executing the matching operation comprises constructing an ordered list of available token quantities, sorting the ordered list based on a composite score computed from a price parameter, a time parameter, and a policy-derived weighting factor, iteratively selecting token quantities from the ordered list until the requested energy quantity is satisfied, and generating the settlement record including identifiers of selected token quantities and associated pricing data.

7. The method of claim 1, wherein locking the payment amount and the token quantity comprises creating escrow entries including a payment lock identifier and a token lock identifier, associating the escrow entries with the settlement record, storing a lock state indicator in the settlement state, and preventing modification or release of the escrow entries until execution of the single atomic state transition; and wherein receiving the signed delivery evidence further comprises computing the meter-evidence hash by applying a cryptographic hash function to the signed meter record, retrieving a stored hash reference corresponding to the signed meter record from the permissioned consortium network, and comparing the meter-evidence hash with the stored hash reference to validate integrity of the signed meter record.

8. The method of claim 1, wherein comparing the delivered-energy value with the requested energy quantity comprises computing an energy deviation value, comparing the energy deviation value with a tolerance threshold stored in the settlement state, and maintaining the escrow entries in a locked state when the energy deviation value exceeds the tolerance threshold, while recording a deviation indicator in the audit state; and wherein executing the single atomic state transition comprises generating a transaction record including the payment amount, the token quantity, and the delivered-energy value, applying a consensus validation procedure across the permissioned consortium network, and updating the settlement state and audit state in a single write operation such that intermediate release of either the payment amount or the token quantity is prevented.

9. The method of claim 1, wherein storing the signed meter record comprises encrypting the signed meter record using an encryption key associated with the consortium control system, generating a corresponding hash reference using a cryptographic hash function, storing the signed meter record in storage external to the permissioned consortium network, and storing the corresponding hash reference within the permissioned consortium network to enable later verification without exposing encrypted signed meter records.

10. The method of claim 1, wherein generating the session token further comprises encoding the session token as a structured data object including the session pseudonym, a token identifier, a validity interval, and a nonce reference, computing a token hash by applying a cryptographic hash function over the structured data object, signing the token hash using a private key associated with the consortium control system to generate a signed token value, storing the token hash in the audit state, and validating the session token during subsequent processing by recomputing the token hash and comparing it with stored token hash.

11. The method of claim 1, wherein computing the token quantity further comprises normalizing the energy value into a standardized unit, applying the tokenization factor using fixed-point arithmetic with a predefined precision parameter, generating an intermediate token value, performing truncation of the intermediate token value based on the predefined precision parameter, and storing truncated token value as the token quantity in the renewable token state; and wherein locking the payment amount and the token quantity comprises generating a payment lock identifier and a token lock identifier, associating the payment lock identifier and the token lock identifier with the settlement record, storing a lock state indicator in the settlement state, and preventing modification of the payment amount and the token quantity by rejecting any state update request that does not include both the payment lock identifier and the token lock identifier, and wherein validating correspondence between the meter-evidence hash and the signed meter record comprises computing a first hash over the signed meter record, concatenating the first hash with a session identifier to form a concatenated value, computing a second hash over the concatenated value, and comparing the second hash with a stored hash reference in the permissioned consortium network.

12. The method of claim 1, wherein executing the single atomic state transition comprises generating a transaction input sequence including the payment amount, the token quantity, the delivered-energy value, and the meter-evidence hash, computing a transaction digest by applying a cryptographic hash function to the transaction input sequence, submitting the transaction digest for validation by the permissioned consortium network, and updating the settlement state and the audit state in a single write operation only upon validation of the transaction digest; and wherein validating the nonce-bound credential proof further comprises maintaining a bounded nonce-cache structure indexed by the station identifier and the session pseudonym, storing accepted nonce values in the bounded nonce-cache structure along with corresponding temporal values, evicting stored nonce values based on a least-recently-used sequence when a storage threshold is reached, and rejecting the nonce-bound credential proof when the cryptographic challenge nonce matches any nonce value retained within the bounded nonce-cache structure.

13. The method of claim 1, wherein generating the session token further comprises associating the session token with a state-transition constraint table stored in the audit state, the state-transition constraint table defining permissible transitions between session states including admitted, charging, evidence-pending, finalized, and disputed, and validating each state transition by comparing a requested state transition with entries in the state-transition constraint table prior to updating the session record; and wherein executing the matching operation further comprises constructing a deterministic ordering sequence of available token quantities by computing a composite ordering value for each token quantity using a weighted combination of a price parameter, a timestamp parameter, and a source identifier, sorting the available token quantities based on the composite ordering value, and selecting token quantities sequentially according to sorted ordering sequence.

14. The method of claim 1, wherein receiving the signed delivery evidence further comprises generating a sequence of intermediate metering values during the charging session, computing a cumulative energy value from the sequence of intermediate metering values, comparing the cumulative energy value with the delivered-energy value included in the signed delivery evidence, and rejecting the signed delivery evidence when a deviation between the cumulative energy value and the delivered-energy value exceeds a predefined deviation threshold, and wherein validating the nonce-bound credential proof further comprises maintaining, within the identity registry state, a bounded nonce-cache data structure indexed by a combination of the station identifier and the session pseudonym, storing each accepted cryptographic challenge nonce in the bounded nonce-cache data structure together with an associated timestamp and a usage flag, updating the usage flag upon successful verification of the nonce-bound credential proof, evicting entries from the bounded nonce-cache data structure based on a least-recently-used ordering when a predefined storage threshold is exceeded, and rejecting a subsequently received nonce-bound credential proof when the cryptographic challenge nonce matches any stored nonce value within the bounded nonce-cache data structure that has a timestamp within a predefined retention interval.

15. The method of claim 1, wherein receiving the signed delivery evidence further comprises acquiring a sequence of intermediate metering values during the charging session, storing the sequence of intermediate metering values in association with the session record, computing a cumulative energy value by aggregating the sequence of intermediate metering values using an accumulation function, comparing the cumulative energy value with the delivered-energy value included in the signed delivery evidence to determine a deviation value, and rejecting the signed delivery evidence when the deviation value exceeds a predefined deviation threshold stored in the settlement state.

16. The method of claim 1, wherein executing the single atomic state transition further comprises generating a pre-commit record including the payment amount, the token quantity, the delivered-energy value, and the meter-evidence hash, computing a pre-commit hash by applying a cryptographic hash function over the pre-commit record, storing the pre-commit hash in the audit state, validating the pre-commit hash against a consensus validation process within the permissioned consortium network, and completing the single atomic state transition only after successful validation of the pre-commit hash, such that partial updates to the settlement state are prevented.

17. The method of claim 1, wherein storing the signed meter record further comprises segmenting each signed meter record into a plurality of data fragments, encrypting each data fragment using an encryption key associated with the consortium control system, generating a fragment hash for each encrypted data fragment, computing a composite hash by applying a cryptographic hash function over a concatenation of the fragment hash, storing the encrypted data fragment in distributed storage external to the permissioned consortium network, and storing the composite hash within the permissioned consortium network to enable verification of integrity of segmented signed meter record.
